(19) United States
(12) Patent Application Publication
(10) Pub. No.: US 2015/0038206 A1
(43) Pub. Date: Feb. 5, 2015

(54) METHODS OF ADMINISTERING WAGERING GAMES INCLUDING TRADING CARDS AND RELATED SYSTEMS

(71) Applicant: SHFL entertainment, Inc., Las Vegas, NV (US)

(72) Inventors: Barbara J. Walton, Rockledge, FL (US); Edith M. Walton, Rockledge, FL (US); David J. Walton, Melbourne, FL (US); Roger M. Snow, Las Vegas, NV (US)

(21) Appl. No.: 14/319,924

(22) Filed: Jun. 30, 2014

Related U.S. Application Data
(60) Provisional application No. 61/860,254, filed on Jul. 31, 2013.
(60) Provisional application No. 61/887,356, filed on Oct. 5, 2013.
(60) Provisional application No. 61/894,887, filed on Oct. 23, 2013.
(60) Provisional application No. 61/905,768, filed on Nov. 18, 2013.

(51) Int. Cl. G07F 17/32; A63F 1/00

(52) U.S. Cl. CPC G07F 17/3293; A63F 1/00; G07F 17/3225
USPC 463/11; 273/292

(57) ABSTRACT

Methods of administering wagering games include administering an opportunity for at least one player to trade at least one card of the player hand and comparing a highest ranking card of the player hand to a highest ranking card of a dealer hand. Methods of administering such wagering games may be performed over a network utilizing a processor.

### CROSS-REFERENCE TO RELATED APPLICATIONS

This application claims the benefit of U.S. Provisional Patent Application Ser. No. 61/860,254, filed Jul. 31, 2013, by Walton et al., U.S. Provisional Patent Application Ser. No. 61/887,356, filed Oct. 5, 2013, by Walton et al., U.S. Provisional Patent Application Ser. No. 61/894,887, filed Oct. 23, 2013, by Walton et al., and U.S. Provisional Patent Application Ser. No. 61/905,768, filed Nov. 18, 2013, by Walton et al., the disclosure of each of which is incorporated herein in its entirety by this reference.

### FIELD

This disclosure relates generally to methods of administering wagering games for casinos and other gaming establishments, and related systems and apparatuses. More specifically, disclosed embodiments relate to methods of administering wagering games including the option for a player to trade at least one player card and related systems and apparatuses.

### BACKGROUND

Wagering games based on the outcome of randomly generated or randomly selected symbols are well known. Such games are widely played in gaming establishments such as casinos. The wagering games include card games, wherein the symbols comprise familiar, common playing cards. Card games such as twenty-one (also known as “blackjack”), poker, variations of poker, high card games (e.g., CASINO WAR®), and the like are excellent card games for use in casinos. Desirable attributes of casino card games are that the games are exciting, they can be learned and understood easily by players, and they move or are played rapidly to a wager-resolving outcome.

Game administrators, such as casinos or other gaming establishments, frequently seek new games to offer to their clientele. Such games are often administered with one or more players playing against a dealer (who may also act as the banker) provided by the game administrator. Alternatively, the games may be administered with players playing against each other. In “card room” games, each player may have the option to act as a banker, while the gaming establishment administers the game and takes fees from the players.

Players typically enjoy games that can be played rapidly and that offer players a choice. Such choices may heighten player interest in games.

U.S. Pat. No. 5,324,041 (Boylan et al.), issued Jun. 28, 1994, describes a casino game that is a variant of the conventional parlor game called “War.” In this game, the dealer deals one card, face up, to each of the players as well as a face up card to themselves. Taking each player in turn, the dealer determines whether the numerical value (i.e., rank) of the card of the player is greater than, less than, or equal to the rank of the dealer's card. If the value of the card of the player is less than or equal to that of the dealer, the player loses an ante bet which is immediately collected from area by the dealer. If the value of the card of the player is greater than that of the dealer, the player wins and the dealer immediately pays the player an amount, such as, an amount equal to the ante bet of that player. If the value of the card of the player and dealer are equal, additional cards may be dealt to each of the player and the dealer. In this scenario, the player may make an additional tie bet on the additional cards dealt. This game is marketed under the name CASINO WAR® by SHFL entertainment, Inc. of Las Vegas, Nev.

Accordingly, conventional wagering games, including conventional high card-type and War-type games, often involve little to no interaction by the player. For example, in a War-type game, the only opportunity for additional betting is during the occurrence of a tie between the player and the dealer. Further, there is no opportunity for card selection by the player. Finally, the ante wagers generally pay even money when the wagers are won.

### BRIEF SUMMARY

In some embodiments, the present disclosure includes a method of administering a wagering game. The method includes accepting from at least one player at a player position on a playing device layout an ante wager of at least one tangible gaming chip at an ante wager area on the playing device layout; dealing at least one card from a randomized set of physical playing cards to the at least one player at the player position for a player hand; dealing at least one card from the randomized set of physical playing cards for a dealer hand to a dealer position; allowing the at least one player to view the player hand; administering an opportunity for the at least one player to trade at least one card of the player hand; exposing the dealer hand to the at least one player; comparing a highest ranking card of the player hand to a highest ranking card of the dealer hand; and resolving the ante wager comprising: removing at least one tangible gaming chip from the playing device layout if the highest ranking card of the dealer hand outranks the highest ranking card of the player hand; and paying at least one tangible gaming chip to the at least one player if the highest ranking card of the player hand outranks the highest ranking card of the dealer hand.

In additional embodiments, the present disclosure includes a method of administering a wagering game. The method includes providing a playing device layout comprising at least one player position and a dealer area, the at least one player position of the playing device layout bearing at least three distinct wager areas comprising an ante wager area, a raise wager area, and a trade wager area, and a player card receiving area, the ante wager area, the raise wager area, and the trade wager area, each defined by separate insignia displayed on the playing device layout, the dealer area bearing a dealer card receiving area defined by insignia displayed on the playing device layout; accepting from at least one player at the at least one player position an ante wager of at least one tangible gaming chip at the ante wager area; dealing one card from a randomized set of physical playing cards to the at least one player for a player hand to the player card receiving area; dealing two cards from the randomized set of physical playing cards for a dealer hand to the dealer card receiving area; allowing the at least one player to view the player hand; and administering an opportunity for the at least one player to trade at least one card of the player hand. The administering includes at least one of receiving an indication of standing from the at least one player; accepting from the at least one player at the at least one player position a trade wager of at least one tangible gaming chip at the trade wager area on the playing device layout; and accepting from the at least one player at the at least one player position a raise wager of at least one tangible gaming chip at the raise wager area on the playing device layout. The method further includes exposing the dealer hand to the at least one player to the dealer card receiving area; comparing the player hand to the dealer hand; and resolving at least one of the ante wager, the trade wager, and the raise wager. The resolving including at least one of removing at least one tangible gaming chip from the playing device layout when at least one card of the two cards of the dealer hand outranks the one card of the player hand; paying at least one tangible gaming chip to the at least one player when the one card of the player hand outranks at least one card of the two cards of the dealer hand; and returning at least one tangible gaming chip to the at least one player when the one card of the player hand is equal in rank to at least one card of the two cards of the dealer hand.

In yet additional embodiments, the present disclosure includes a method of administering a wagering game over a network utilizing a processor. The method includes receiving, at a processor, an indication that an ante wager to participate in the wagering game is accepted from a player; determining, utilizing the processor, a player hand associated with the player, the player hand including at least one randomized playing card from a set of playing cards; determining, utilizing the processor, a dealer hand, the dealer hand including at least one randomized playing card from the set of playing cards; providing, from the processor, the player hand to a user device associated with the player for displaying the player hand on the associated user device; receiving, at the processor, an election from the at least one player to trade at least one card of the player hand; providing, from the processor, the dealer hand to the user device associated with the player for displaying the dealer hand on the associated user device; resolving the ante wager by comparing a highest ranking card of the dealer hand to a highest ranking card of the player hand.

Yet other embodiments may comprise apparatuses and systems for administering wagering games according to embodiments of the disclosure.

### BRIEF DESCRIPTION OF THE DRAWINGS

While the disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a flowchart diagram of a method of administering a wagering game, according to an embodiment of this disclosure;

FIG. 2 is a diagram of a playing surface for implementation of a method of administering a wagering game, according to an embodiment of this disclosure;

FIG. 3 is an enlarged diagram of a player position of the playing surface of FIG. 2;

FIG. 4 is a perspective view of a gaming table configured for implementation of embodiments of wagering games in accordance with this disclosure;

FIG. 5 is a perspective view of an individual electronic gaming device configured for implementation of embodiments of wagering games in accordance with this disclosure;

FIG. 6 is a top view of a table configured for implementation of embodiments of wagering games in accordance with this disclosure;

FIG. 7 is a perspective view of another embodiment of a table configured for implementation of embodiments of wagering games in accordance with this disclosure, wherein the implementation includes a virtual dealer;

FIG. 8 is a schematic block diagram of a gaming system for implementing embodiments of waging games in accordance with this disclosure;

FIG. 9 is a schematic block diagram of a gaming system for implementing embodiments of wagering games including a live dealer feed;

FIG. 10 is a block diagram of a computer for acting as a gaming system for implementing embodiments of wagering games in accordance with this disclosure;

FIG. 11 is a schematic of a scratch card implementation of a wagering game in accordance with this disclosure;

FIG. 12 is an enlarged diagram of a player position of a playing surface for implementation of a method of administering a wagering game, according to an embodiment of this disclosure; and

FIG. 13 is an enlarged diagram of a player position of a playing surface for implementation of a method of administering a wagering game, according to an embodiment of this disclosure

### DETAILED DESCRIPTION

The illustrations presented in this disclosure are not meant to be actual views of any particular act in a method, apparatus, system, or component thereof, but are merely idealized representations employed to describe illustrative embodiments. Thus, the drawings are not necessarily to scale. Additionally, elements common between figures may retain the same or similar numerical designation. Elements with the same number, but including a different alphabet character as a suffix should be considered as multiple instantiations of substantially similar elements and may be referred generically without an alphabet character suffix.

The terms “gaming,” “gambling,” or the like, refer to activities, games, sessions, rounds, hands, rolls, operations, and other events related to wagering games, the outcome of which is at least partially based on one or more random events (“chance” or “chances”), and on which wagers may be placed by a player. In addition, the words “wager,” “bet,” “bid,” or the like, refer to any type of wager, bet, or gaming venture that is placed on random events, whether of monetary or non-monetary value. Points, credits, and other items of value may be purchased, earned, or otherwise issued prior to beginning the wagering game. In some embodiments, purchased points, credits, or other items of value may have an exchange rate that is not one-to-one to the currency used by the user. For example, a wager may include money, points, credits, symbols, or other items that may have some value related to a wagering game. Wagers may be placed in wagering games that involve the risk of real-world monetary value for the potential of payouts with real-world monetary value (e.g., the “play-for-pay,” such as “house-banked,” “player-banked,” and “dividend refund” configurations, each of which is described in more detail below) or in wagering games that involve no real-world monetary risks for the player (e.g., the “play-for-fun” and “social play-for-fun” configurations described in more detail below).

As used herein, the term “wager” includes any form of wagering value, including money, casino chips, other physical means for payment, and online or remote electronic authorization of a wager in any acceptable form to the casino or online or virtual game host. Also included are physical representations of money (e.g., casino chips) at a local gaming establishment, as well as virtual representations of money in the form of electronic authorizations of a transfer of money and digital representations of money (e.g., digital representations of bills or coins, digital representations of chips, numerical quantities of money, numerical quantities of points, or numerical quantities of credits) at a local or remote electronic gaming device. As used herein, the term “wagering element” means and includes objects and symbols used to signify the acceptance of a wager. For example, physical wagering elements include physical money (e.g., bills and coins) and physical wagering tokens (e.g., poker chips), which may or may not be redeemable for monetary value and may or may not include electronic identifiers (e.g., RFID chips) embedded within the tokens, enabling electronic sensing and tracking of wagering. Virtual wagering elements include, for example, images (e.g., images of money or poker chips) and text (e.g., a string of numbers), which may or may not be redeemable for monetary value. In the “play-for-fun” and “social play-for-fun” configurations, a “wager” may not have a cash value (i.e., a real-world monetary value).

For the purposes of this description, it will be understood that when an action related to accepting wagers, making payouts, dealing cards, selecting cards, or other actions associated with a player or a dealer is described herein, and such description includes a player or a dealer taking the action, the results of the action may be computer generated and may be displayed on a live or virtual table or electronic display, and, if applicable, the reception or detection of such an action in an electronic form where player and dealer choices, selections, or other actions are received at an electronic interface. This further includes the results of a virtual dealer and virtual players, where the actions described are actually generated by a computer (typically associated with an online game). By way of a further example, if dealing of a card is described herein, the description includes (but is not limited to) the following: the dealing of a card by a dealer from a deck, shuffler, shoe, or other card source and the reception or placement of the card at a table location associated with a player or reception directly by a player; the generation and transmission of an electronic indication or representation of a card from a game play source or server to an electronic receiver, where the receiver may be at a table (using virtual cards) including players and/or virtual players and/or a dealer or virtual dealer, on a gaming terminal, at a public display in a casino, at a remote location (e.g., using online or Internet game play), or at other locations. Also included is the representation of a card on a display or displays, and, if applicable to the action described, an electronic reception of an indication that the card has been received, selected, or otherwise interacted with at a location associated with a player, or, associated with a virtual player. In addition, dealing of a card may refer to revealing a representation of a card on a scratch-off card (also referred to as “scratchers”).

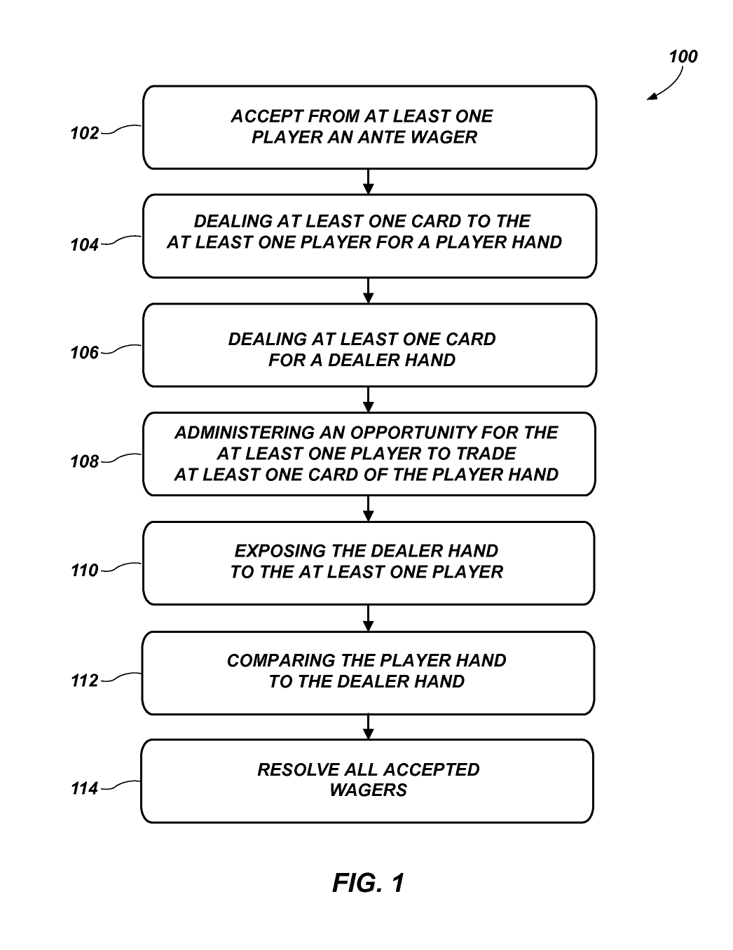

Referring to FIG. 1, a flowchart diagram of a method of administering a wagering game is shown. As shown in FIG. 1, the method 100 includes accepting from at least one player an ante wager (operation 102), dealing at least one card (e.g., one card) to the at least one player for a player hand (operation 104), dealing at least one card (e.g., two cards) for a dealer hand (operation 106), administering an opportunity for the at least one player to receive at least one additional, differing card for the player hand, for example, to trade (e.g., swap, replace, exchange, switch) at least one card of the player hand (operation 108), exposing the dealer hand (e.g., the complete dealer hand) to the at least one player (operation 110), comparing the player hand to the dealer hand (e.g., a rank of the player hand to a rank of the dealer hand) (operation 112), and resolving all accepted wagers (operation 114).

Administering the wagering game includes administering at least one round of the wagering game. Administration may be conducted by a casino through its personnel, or may be administered using a processor. With further reference to FIG. 1, administration of a round may begin, as indicated at operation 102, with accepting from a player a wager (e.g., an ante wager). The ante wager may be designated as a wager against the dealer (e.g., a wager designated to be resolved based on a rank comparison of a player hand rank and a dealer hand rank). In some embodiments, a payout on the ante wager, for meeting a winning condition, may be paid according to a paytable, as discussed below. In other embodiments, a payout on the ante wager, for meeting a winning condition, may be an even money payout (e.g., a payout equal to the ante wager, 1:1). In yet other embodiments, the ante payout may be awarded based on a multiple of the ante wager, such as 2× the ante wager.

The ante wager, and any other wager simultaneously or subsequently accepted from the player, may be accepted by, for example, electronically accepting funds from a player account or other credit authorized via one or more communications media (e.g., via the Internet, wireless communications, land line) on a remote electronic device (e.g., a personal computer, a laptop, a tablet computer, or a smartphone) by player input, electronically accepting funds from a player account authorized on a local wagering game administration device in a casino by player input, or accepting money or representations of money (e.g., chips) physically placed on a table in a designated betting area on a live gaming table surface in a casino. The gaming system that accepts wagers from online players may be the same system or a different system from the system that administers the actual game and game results. Suitable network architecture for administering casino style games and game results to an online casino gaming system is disclosed in U.S. Patent Application Publication No. 2013/0184059, published Jul. 18, 2013, to Costello et al., and U.S. Patent Application Publication No. 2013/0184079, also published Jul. 18, 2013, to Costello et al., the disclosures of which are incorporated herein in their entirety by this reference. The gaming system described in the Costello publications delivers game results, but does not administer client or casino funds.

One example of a suitable, local (i.e., traditional casino gaming equipment) wagering game administration device may comprise, for example, the chipless tables disclosed in U.S. Patent Application Publication No. 2010/0016050, published Jan. 21, 2010, to Snow et al., the disclosure of which is incorporated herein in its entirety by this reference.

Regardless of the form and manner in which the ante wager is received, ante wagers may be received from multiple players wanting to participate in the round of the wagering game. The ante wager may be mandatory such that its acceptance is a prerequisite to completing the administration of the round with the player. The ante wager may be subjected to amount limitations, such as table minimums and/or maximums, and may be received prior to revealing any cards potentially at play in the round of the game.

In examples described in the specification, the game is played with one or more standard 52-card decks (e.g., six or eight decks) of physical (e.g., tangible) or virtual cards (i.e., ranks of 2 through 10, Jack, Queen, King and Ace, of clubs, hearts, diamonds and spades). In some embodiments, one or more cards (e.g., two Aces) may be removed from the standard deck before use in the wagering game. In other forms, jokers or other wild cards may be present, special decks may be used (such as decks with certain cards removed), or multiple intermixed decks of cards may be used to administer the game. Special cards may be inserted into the deck, additional suits added, etc. It is understood that changing the deck composition changes the game math and may require that some of the rules be modified in order for the game to be commercially acceptable. In examples, the game is played with a set of six or eight standard decks of cards, and the cards are dealt from a shoe. In other embodiments, cards are dealt from a continuous shuffler such as the One2Six™ shuffler, manufactured by SHFL entertainment, Inc., Las Vegas, Nev.

Though the descriptions herein may focus on administration of the wagering game with participation from “a player” or “the player,” it should be understood that each round may include administration, with the same acts (though outcomes and decisions may be different) to a plurality of players.

As another example, one or more side (e.g., bonus) wagers may be received. A side wager may be optional, subjected to minimums and/or maximums, and may be received prior to revealing any cards potentially at play in the round of the game. In other embodiments, however, one or more cards (player or dealer) may be revealed prior to acceptance of the side wager.

For example, and as discussed below, a side wager may be designated as a Card Bonus wager (e.g., a “3 Card Bonus®” wager, by SHFL entertainment, Inc.). Such a side wager may include a side or bonus wager against a paytable and for which a winning condition is a player side hand rank of at least a flush where the player side hand is formed by one or more cards of the player hand and one or more cards of the dealer hand. For example, the player side hand may be formed with the one card of the player hand and the two cards of the dealer hand as discussed below in greater detail.

In other embodiments, a side wager may be designated as a “Perfect Match” side wager, designated as a wager against a paytable and for which a winning condition is a player hand rank of when the player card at least ties a dealer card.

In yet other embodiments, a side wager may be designated as a “Pair Plus®” (by SHFL entertainment, Inc.) side wager, designated as a wager against a paytable and for which a winning condition is a player hand rank of at least one pair.

In some embodiments, one acceptable side wager may be a progressive side wager, designated as a wager for which a winning condition is, e.g., a predetermined hand combination or premium hand composition. A payout on the progressive side wager may be based on a percentage of a progressive pot, on a paytable, on a fixed basis, or combinations thereof. In some embodiments in which progressive side wagers are acceptable, acceptance of the progressive side wager may not only qualify a player for the potential progressive payout, but may also qualify the player for a potential “envy” payout in the event of a progressive payout being paid to another participating player.

In some examples of the disclosure, all wagers, including optional side wagers, except for the ante, remain in play when the dealer hand does not qualify. For example, the dealer hand must be a selected rank (e.g., 6 or greater, 7 or greater, 8 or greater), otherwise the ante bet is returned to the player. In one form of the disclosure, a player may not win a progressive payout on an optional side bet unless the dealer hand qualifies. In the event that the dealer hand does not qualify, the dealer may, for example, return the ante wager to the player and maintain (e.g., continue play with) the raise and trade wagers or may return all wagers.

At least one card may be dealt for a player hand, as indicated at operation 104 of FIG. 1. The player may be allowed to view the one or more cards before any additional wagering is performed in the game. The one or more card may be dealt face up, face down, or combination thereof (e.g., two cards face down and one card face up).

In some embodiments, one card may form the player hand. In other embodiments, more than one card (e.g., two, three, four, or more cards) may form the player hand. For example, as discussed below in greater detail, three cards may be dealt to the player hand. The player is only allowed to view one of the three cards and is given the opportunity to trade the one card for one of the other two cards of the three dealt to the player hand.

In some embodiments, the player card or cards may be dealt face-down, with the values thereof being concealed to all but the player for whom the cards are designated such that each player in a round of the game is made aware of the values of only one of that player's cards at this stage in the game. In other embodiments, the player cards may be dealt face-up.

Before, concurrently with, or after dealing the at least one player card for the player hand (operation 104), the dealer may deal a number of cards for the dealer hand, as indicated at operation 106. For example, this dealing operation may complete the dealer hand, such that the dealer hand consists of the number of cards dealt at operation 106. In some embodiments, two cards may form the dealer hand. In such an embodiment, the dealer hand may be formed by selecting the highest ranking card of the two dealer cards to form the dealer hand. In other embodiments, other amounts of cards (e.g., one, three, four, or more cards) may foam the dealer hand. As discussed below in greater detail, in some embodiments, the player may be given the opportunity to receive one or more of the cards farming the dealer hand by trading one or more cards in the player hand.

After the player has viewed the one or more cards of the player hand, the administrator (e.g., dealer) administers an opportunity for the at least one player to trade at least one card of the player hand, as indicated at operation 108 of FIG. 1. For example, the player is given an opportunity to trade one or more cards (e.g., one card) forming the player hand. In embodiments where the player hand comprises one card, the player is given the opportunity to replace the entire player hand. In some embodiments, the trade may comprise the discarding of the one or more cards (e.g., the dealer taking the one or more cards) and the replacing of the one or more cards by dealing an amount of cards equal to the amount of cards discarded to the player. For example, the dealer may deal one or more cards to the player hand from one or more decks of cards. In other embodiments, the player may receive a replacement card from the dealer hand. For example, the dealer may provide the player an opportunity to select one or more cards from the dealer hand (e.g., by placing a trade wager in an area corresponding to the card the player wants to select). In such an embodiment, the dealer may replace the card taken from the dealer hand by the player with another card from the deck or with discarded (i.e., traded) card from the player hand. In yet other embodiments, the player hand may include additional face-down cards that may be used to replace the one or more discarded cards (e.g., by placing a trade wager in an area corresponding to the card the player wants to select). For example, the player may be given an opportunity to select one of two or more face-down cards dealt to the player hand to replace the one or more discarded cards (e.g., by placing a trade wager in an area corresponding to the card the player wants to select).

In some embodiments, any cards that were traded or discarded by the player may be placed into the dealer hand. In other embodiments, the traded cards are discarded.

In some embodiments, in order to trade one or more cards, the dealer may receive a trade wager from the player. The trade wager may be designated as a wager against the dealer (i.e., a wager designated to be resolved based on a rank comparison of a player hand rank and a dealer hand rank). In some embodiments, a payout on the trade wager, for meeting a winning condition, may be paid according to a paytable, as discussed below. For example, the trade wager may be paid with and according to the same paytable as the ante wager. In other embodiments, a payout on the trade wager, for meeting a winning condition, may be an even money payout (e.g., a payout equal to the ante wager, 1:1). In other embodiments, the trade wager payout may be awarded based on a multiple of the trade wager, such as 2× the trade wager.

In some embodiments, the trade wager may be an amount base on a multiple of the ante wager. For example, the trade wager may be the same as the ante wager (1×). In other embodiments, the trade wager may be a greater multiple of the ante wager (e.g., 2×, 3×, 4×, or greater).

In some embodiments, the dealer may accept an indication of checking (e.g., standing with no additional wagers) if the player does not want to trade a card (e.g., does not want to place the trade wager).

In some embodiments, after viewing the player hand, the player may be given the opportunity to place a raise wager (e.g., double down). For example, the dealer may accept a raise wager from the player after the player has viewed the player hand. The raise wager may be designated as a wager against the dealer (i.e., a wager designated to be resolved based on a rank comparison of a player hand rank and a dealer hand rank). In some embodiments, a payout on the raise wager, for meeting a winning condition, may be paid according to a paytable, as discussed below. For example, the raise wager may be paid with and according to the same paytable as at least one of the ante wager and the trade wager. In other embodiments, a payout on the raise wager, for meeting a winning condition, may be an even money payout (e.g., a payout equal to the ante wager, 1:1). In other embodiments, the raise wager payout may be awarded based on a multiple of the raise wager, such as 2× the raise wager.

In some embodiments, the raise wager may be an amount base on a multiple of the ante wager. For example, the raise wager may be the same as the ante wager (1×). In other embodiments, the raise wager may be a greater multiple of the ante wager (e.g., 2×, 3×, 4×, or greater).

As above, in some embodiments, the dealer may accept an indication of checking (e.g., standing with no additional wagers) if the player does not want to place at least one of the raise wager and the trade wager.

In some embodiments, the dealer may accept (e.g., may only accept) the raise wager from a player only if the trade wager is not received from the player. In other words, the dealer may receive from the player only one of an indication of checking, the trade wager, and the raise wager. In other embodiments, the dealer may accept (e.g., may allow) the raise wager from a player who also previously made the trade wager. In embodiments, a dealer may accept a trade wager, then a raise wager.

The dealer hand is exposed to the at least one player, as indicated at operation 110. The cards for the dealer hand may be dealt to initially be face-down and then thereafter exposed to the player, such that operations 106 and 110 are carried out sequentially. In other embodiments, exposing the dealer hand to the player may include dealing the cards for the dealer hand face up, such that operations 106 and 110 are carried out simultaneously.

As mentioned above, in some embodiments, the dealer may have a plurality of cards and may select one or more cards having the highest rank. For example, the dealer may select one card of two cards that has the highest rank after the dealer hand is exposed to the player. As also mentioned above, in some embodiments, any cards that were traded or discarded by the player at operation 108 may also be used to form the dealer hand. In some of such embodiments, the dealer may only use the cards traded or discarded by the player if those cards have a selected rank (e.g., 6 or greater, 7 or greater, 8 or greater). Otherwise, or if there are no traded or discard cards, the dealer will utilize the cards dealt to the dealer hand.

The dealer hand is compared to the player hand, as indicated at operation 112. For example, each player hand may be compared to the dealer hand to determine: (1) if the player hand contains a card having a rank that is greater than a rank of a card of the dealer hand, (2) if the dealer hand contains a card having a rank that is greater than a rank of a card of the player hand, and (3) if the dealer hand contains a card having a rank equal to a rank of a card of the player hand. In embodiments where a standard deck of cards it utilized (e.g., a stand set of multiple decks), the dealer hand and player hand may evaluated using the ranks of 2 through 10, Jack, Queen, King, and Ace, where 2 is the lowest rank and Ace is the highest. In other embodiments, an Ace may be the lowest rank and the King is the highest. In some such embodiments, a predetermined event (e.g., the dealer hand containing one or more Aces, for example, two Aces) may act to change Aces from the lowest rank to the highest rank in the dealer and player hands. In some embodiments, the card suit may also be utilized to compare the dealer and player hands instead of or in addition to the rank of the card.

All accepted wagers may then be resolved, as indicated at operation 114, which includes resolving the ante wager, the raise wager, and trade wager if one or more of the raise wager and trade wager was accepted by the dealer as discussed above. Resolving the ante, raise, and trade wagers may be based, at least in part, on the comparison of the dealer and player hands discussed above in operation 112. If the player hand contains a card having a rank that is greater than a rank of a card of the dealer hand, the dealer may payout the player on the ante, raise, and trade wagers. In some embodiments, the payout of the ante, raise, and trade wagers may be based on a paytable. For example, payout of the ante, raise, and trade wagers may be based on a card (e.g., a high card) of the player hand according to the odds shown in Table I.

### Table I

| Player Card | Odds |
|---|---|
| 6 or higher | 1 to 1 |
| 5 | 2 to 1 |
| 4 | 5 to 1 |
| 3 | 10 to 1 |

In other embodiments, the ante, raise, and trade wagers may be an even money payout (e.g., a payout equal to the ante wager, 1:1). In yet other embodiments, payout of some of the ante, raise, and trade wagers may be even money while others are based on a paytable. In some embodiments, the ante, trade and raise wagers pay a payout of 1:1 unless the player wins with a six or less. In that event, at least one of the ante, trade, and raise wagers are paid 2:1.

In some embodiments, payout of one or more of the ante, raise, trade, and bonus wagers may be based on the difference of card ranks between the winning player hand and the losing dealer hand. For example, a selected difference of card ranks (e.g., eight or more cards ranks) may pays odds greater than 1 to 1 (e.g., King over 5 or Queen over 4 pays 10 to 1, King over 4 pays 20 to 1, etc.) where all other differences less than the selected difference of card ranks would pay 1 to 1. In other embodiments, payout of one or more of the ante, raise, trade, and bonus wagers may be based on the number of Aces in one or more of the dealer and player hands.

If the dealer hand contains a card having a rank that is greater than a rank of a card of the player hand, the dealer may retain (e.g., take) the ante, raise, and trade wagers.

If the dealer hand contains a card having a rank equal to a rank of a card of the player hand (e.g., a push), the dealer may return one or more of the ante, raise, and trade wagers to the player. In other embodiments, the dealer may retain one or more of the ante, raise, and trade wagers in the case of a tie. In yet other embodiments, the dealer may pay one or more of the ante, raise, and trade wagers, as described above, in the case of a tie.

In embodiments requiring dealer qualification, as discussed above, a winning condition for the ante wager may be met by the player hand rank exceeding the dealer hand rank and the dealer hand rank exceeding the predetermined minimum qualifying rank (e.g., 6 or greater, 7 or greater, 8 or greater). The ante wager may push (i.e., a “push condition” may be met, and the ante wager returned to the player) if the dealer hand rank does not at least equal the predetermined minimum qualifying rank or if the dealer hand rank at least equals the predetermined minimum qualifying rank and equals the player hand rank. The ante wager may be retained by the administrator (i.e., a “losing condition” may be met) if the dealer hand rank at least equals the predetermined minimum qualifying rank and the dealer hand rank exceeds the player hand rank.

In some embodiments, the dealer hand need not “qualify,” i.e., need not have at least a minimum rank, in order to fully resolve the wagers as discussed above. In such embodiments, then, the dealer may be said to “always qualify.” In other embodiments, however, the dealer hand may be required to at least meet a predetermined minimum qualification rank or else the ante wager and any other wagers received before evaluation of the dealer hand for qualification may be returned to the player or retained by the dealer in accordance with predetermined house rules.

In embodiments in which a side wager designated as a Card Bonus wager (e.g., a “3 Card Bonus®” wager) has been accepted, the Card Bonus wager may be resolved, during operation 114, by considering a rank of cards from the player hand or of a combination of both the player hand and the dealer hand. For example, in embodiments in which the wagering game is configured as a high card (e.g., War) game, three cards between the player hand (e.g., one card) and the dealer hand (e.g., two cards) may be evaluated to determine a best three-card poker rank. In other embodiments, where the player hand includes more than one card (e.g., two or three cards) the cards of the player hand themselves may be evaluated to determine a best two-card or three-card poker rank or in combination with the dealer cards (e.g., a five-card poker hand). A winning condition for the Card Bonus may be met by the combined rank at least equaling a predetermined minimum bonus rank (e.g., a three-of-a-kind, a straight, flush, etc.). There may be no push condition. A losing condition may be met by the combined rank falling below the predetermined minimum bonus rank. Thus, in some embodiments, the Card Bonus wager may win if the best (e.g., three-card) poker hand formed from the combination of cards from the player hand and dealer hand at least matches a minimum bonus rank, and otherwise loses.

Meeting a losing condition on the Card Bonus wager may trigger the dealer to retain the Card Bonus wager. However, meeting a win condition on the Card Bonus wager may trigger paying the player a payout on the Card Bonus wager, which payout may be defined by a paytable and be based, e.g., at least in part on the combined rank. Thus, the Card Bonus wager may be a wager against a paytable, not a wager against the dealer. For example, the 3 Card Bonus® payout may be an odds payout (i.e., a multiple of the amount of the 3 Card Bonus® wager), such as in the two exemplary paytables shown in Table II below.

TABLE II

| Player Hand Rank | Paytable 1 Odds | Paytable 2 Odds |
|---|---|---|
| Straight Flush | 40 to 1 | 9 to 1 |
| 3 of a Kind | 30 to 1 | 9 to 1 |
| Straight | 10 to 1 | 9 to 1 |
| Flush | 5 to 1 | 9 to 1 |

In embodiments in which a side wager designated as a “Perfect Match” wager has been accepted, the Perfect Match wager may be resolved by again by considering a rank of cards from the player hand and/or of a combination of both the player hand and the dealer hand. For example, in embodiments in which the wagering game is configured as a high card (e.g., War) game, three cards between the player hand (e.g., one card) and the dealer hand (e.g., two cards) may be evaluated to determine a best three-card poker rank. In other embodiments, where the player hand includes more than one card (e.g., two or three cards) the cards of the player hand themselves may be evaluated to determine a best two-card or three-card poker rank or in combination with the dealer cards (e.g., a five-card poker hand). In some such embodiments, a winning condition for the Perfect Match wager may be met by the player hand rank at least equaling a predetermined minimum Perfect Match rank (e.g., when a player card ties a dealer card, etc.). There may be no push condition. A losing condition may be met by the player hand rank falling below the predetermined minimum Perfect Match rank. Thus, in some embodiments, the Perfect Match wager may win if the player hand at least matches a minimum Perfect Match rank, and otherwise loses.

Meeting a losing condition on the Perfect Match wager may trigger the administrator to retain the Perfect Match wager. However, meeting a win condition on the Perfect Match wager may trigger paying the player a payout on the Perfect Match wager, which payout may be defined by a paytable and may be based, e.g., at least in part on the player hand rank. Thus, the Perfect Match wager may be a wager against a paytable, not a wager against the dealer. For example, the Perfect Match payout may be an odds payout (i.e., a multiple of the amount of the Perfect Match wager), such as in Table III below.

TABLE III

| Player Hand Rank | Odds |
|---|---|
| Three-of-a-kind with matching suits | 100 to 1 |
| Three-of-a-kind | 30 to 1 |
| Player card matches a dealer card (suited) | 10 to 1 |
| Player card matches a dealer card (unsuited) | 3 to 1 |

In embodiments in which a side wager designated as a “Pair Plus®” wager has been accepted, the Pair Plus® wager may be resolved by again by considering a rank of cards from the player hand or of a combination of both the player hand and the dealer hand. For example, in embodiments in which the wagering game is configured as a high card (e.g., War) game, three cards between the player hand (e.g., one card) and the dealer hand (e.g., two cards) may be evaluated to determine a best three-card poker rank. In other embodiments, where the player hand includes more than one card (e.g., two or three cards) the cards of the player hand themselves may be evaluated to determine a best two-card or three-card poker rank or in combination with the dealer cards (e.g., a five-card poker hand). In some such embodiments, a winning condition for the Pair Plus® wager may be met by the player hand rank at least equaling a predetermined minimum Pair Plus® rank (e.g., a pair, an ace-high, etc.). There may be no push condition. A losing condition may be met by the player hand rank falling below the predetermined minimum Pair Plus® rank. Thus, in some embodiments, the Pair Plus® wager may win if the player hand at least matches a minimum Pair Plus® rank, and otherwise loses.

Meeting a losing condition on the Pair Plus® wager may trigger the administrator to retain the Pair Plus® wager. However, meeting a win condition on the Pair Plus® wager may trigger paying the player a payout on the Pair Plus® wager, which payout may be defined by a paytable and may be based, e.g., at least in part on the player hand rank. Thus, the Pair Plus® wager may be a wager against a paytable, not a wager against the dealer. For example, the Pair Plus® payout may be an odds payout (i.e., a multiple of the amount of the Pair Plus® wager), such as in Table IV below.

TABLE IV

| Player Hand Rank | Odds |
|---|---|
| Straight flush | 40 to 1 |
| Three-of-a-kind | 30 to 1 |
| Straight | 6 to 1 |
| Flush | 3 to 1 |
| Pair | 1 to 1 |

In embodiments in which a progressive side wager has been accepted, the progressive side wager may be resolved in operation 114 by again considering a rank of at least the player hand. In some embodiments, the progressive side wager may be accepted as a fee that is not returned to the player regardless of whether or not a progressive winning condition is met. There may be no push condition. Such a progressive side wager may be based on the player hand (e.g., three cards, one in play and two that can be selected for trading in operation 108, as discussed above) and the dealer hand (e.g., two cards) to form a five-card poker hand. The progressive wager may be resolved only using player cards, player cards plus discarded trade cards, player cards plus additionally dealt player cards, player cards plus additionally dealt common cards, or player cards, dealer cards or any combination of the above.

Various platforms are contemplated that are suitable for implementation of embodiments of wagering games according to this disclosure. For example, embodiments of wagering games may be implemented as live table games with an in-person dealer, electronic gaming machines, partially or fully automated table games, and fully automated, network-administered games (e.g., Internet games) that either produce game results utilizing a processor, or produce a live video feed of a dealer administering a game from a remote studio.

As previously noted, any of the present methods and games may be played as a live casino table card game, as a hybrid casino table card game (with virtual cards or virtual chips), on a multi-player electronic platform (as disclosed in U.S. patent application Ser. No. 10/764,827, filed Jan. 26, 2004, published as U.S. Patent Application Publication No. 2005/0164759 on Jul. 28, 2005, now abandoned; U.S. patent application Ser. No. 10/764,994, filed Jan. 26, 2004, now U.S. Pat. No. 7,661,676, issued Feb. 16, 2010; and U.S. patent application Ser. No. 10/764,995, filed Jan. 26, 2004, now U.S. Pat. No. 8,272,958, issued Sep. 25, 2012; the disclosure of each of which applications and patents is incorporated herein in its entirety by this reference), on a personal computer for practice, on a hand-held game for practice, on a legally-authorized site on the Internet, or on a play-for-fun site on the interne.

For example, in one embodiment, the players may be remotely located from a live dealer, and a live dealer and a game table may be displayed to players on their monitors via a video feed. The players' video feeds may be transmitted to the dealer and may also be shared among the players at the table. In a sample embodiment, a central station may include a plurality of betting-type game devices and an electronic camera for each game device. A plurality of player stations, remotely located with respect to the central station, may each include a monitor, for displaying a selected game device at the central station, and input means, for selecting a game device and for placing a bet by a player at the player's station relating to an action involving an element of chance to occur at the selected game device. Further details on gambling systems and methods for remotely-located players are disclosed in U.S. Pat. No. 6,755,741 B1, issued Jun. 29, 2004, titled “GAMBLING GAME SYSTEM AND METHOD FOR REMOTELY-LOCATED PLAYERS,” the disclosure of which is incorporated herein in its entirety by this reference.

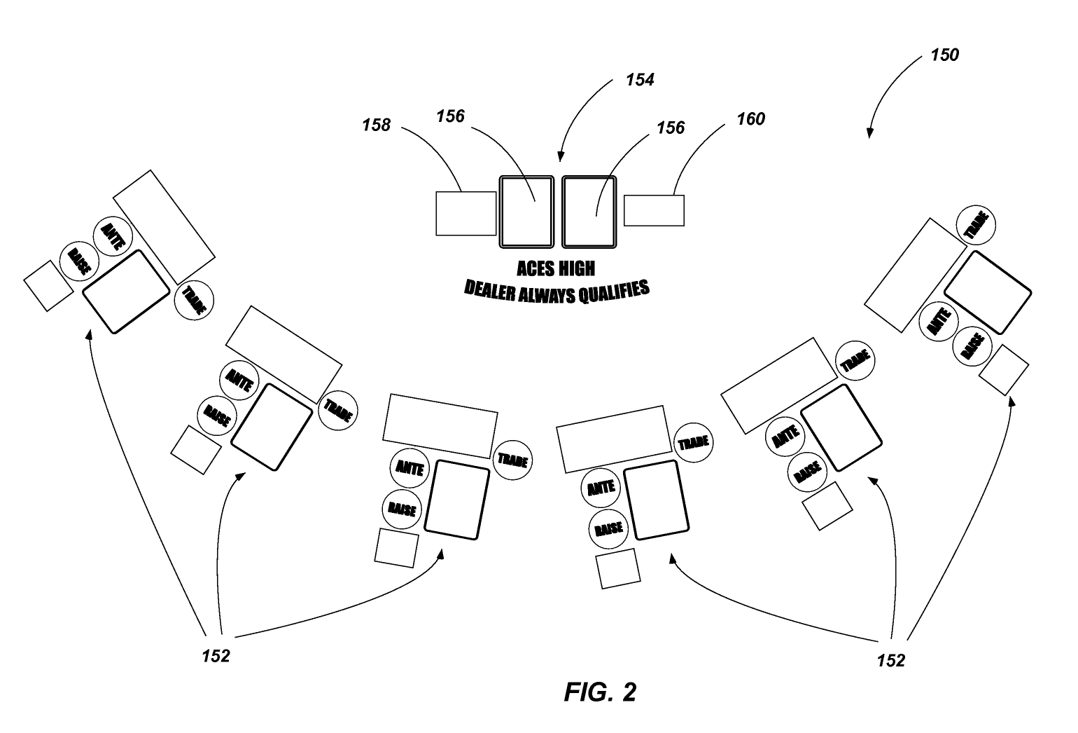

Referring to FIG. 2, shown is a diagram of a playing surface for implementation of the wagering games within the scope of the present disclosure. The gaming table surface 150 (also referred to herein as a “playing device layout”) is provided by the administrator and may include multiple player areas 152 (e.g., six player areas 152). The gaming table surface 150 may be provided with a dealer area 154. For example, the dealer area 154 may include card areas (e.g., two dealer card areas 156) for each card of the dealer hand designated by distinct rectangles having a size substantially similar to (e.g., slightly larger than) the size of a standard playing card. The dealer area may include paytables that are similar to (e.g., identical to) the paytables displayed at each player area 152 as discussed below. For example, the dealer area 154 may include a payable for the ante, raise, and trade wagers (paytable 158) and a paytable for a side wager (paytable 160).

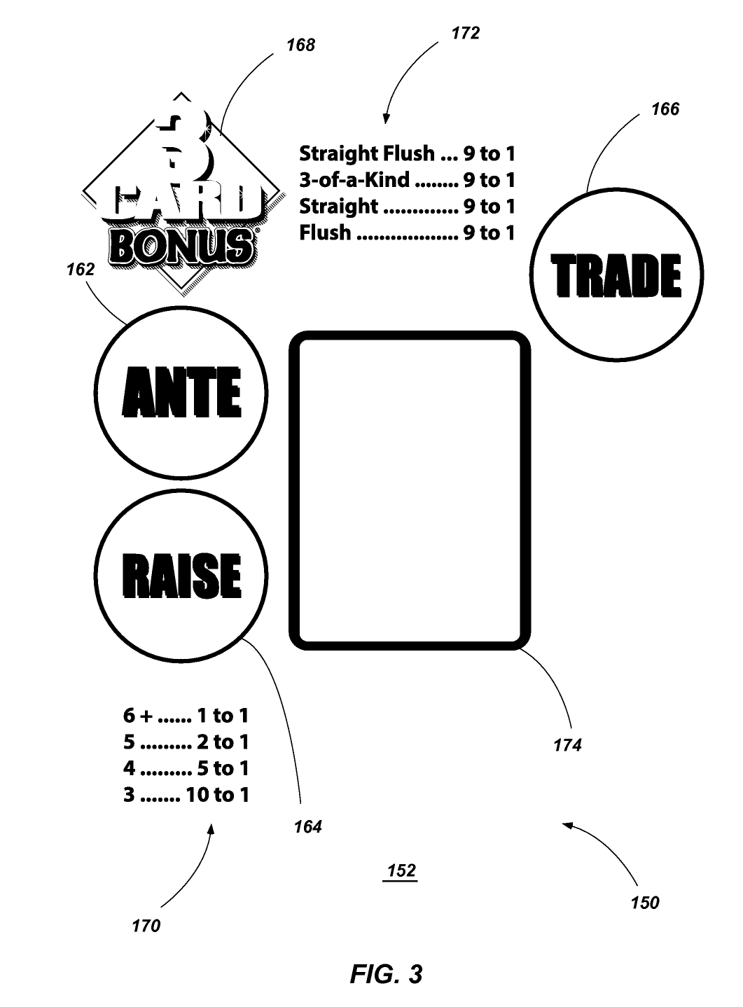

Referring to FIG. 3, illustrated is an enlarged diagram of one of the player positions of the playing surface of FIG. 2. Each player area 152 includes at least three distinct wager areas, including an ante wager area 162, a raise wager area 164, and a trade wager area 166. Distinct areas for each acceptable bonus or side wager 168 (e.g., 3 Card Bonus® wager, a Pair Plus® wager, Perfect Match wager, etc.) may also be included on the gaming table surface 150. In administering a round of the wagering game, wagers are received and at least partially cover their respective wager area, with wager areas being left exposed if no respective wager is accepted. The wager areas of wagers that have been retained may be exposed by the administrator (e.g., dealer).

In some embodiments, such as that illustrated in FIG. 3, the administrator may provide the gaming table surface 150 with the ante wager area 162, the raise wager area 164, and the trade wager area 166 designated by distinct circles. Wager areas for optional bonus or side wagers 168, such as a 3 Card Bonus® wager, a Perfect Match wager, or a Pair Plus® wager, may be designated by distinct non-circular areas (e.g., a diamond, as with 3 Card Bonus® wager area 168).

In some embodiments, the administrator may provide each player area 152 of the gaming table surface 150 with player card area 174 (e.g., designated by a rectangular area).

The gaming table surface 150 may also display paytables, such as, for example, a payable 170 for the ante wager, the raise wager, and the trade wager, and a paytable 172 for a bonus wager.

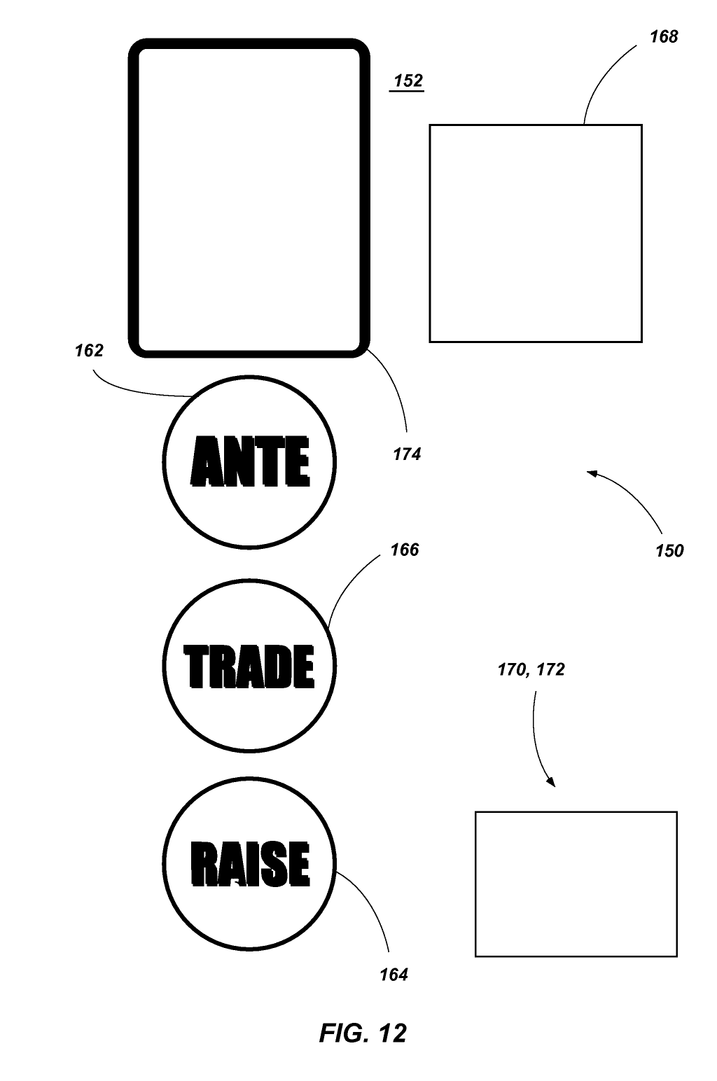

In some embodiments, and as shown in FIG. 12, each player area 152 of the gaming table surface 150 may have a differing layout from that depicted in FIGS. 2 and 3. For example, the ante wager area 162, the raise wager area 164, the trade wager area 166, and the player card area 174 may be substantially aligned vertically. As depicted, each player area 152 of the gaming table surface 150 may optionally include a bonus wager area 168 for optional bonus or side wagers and one or more informational areas including details of the wagering game (e.g., paytable 170, 172).

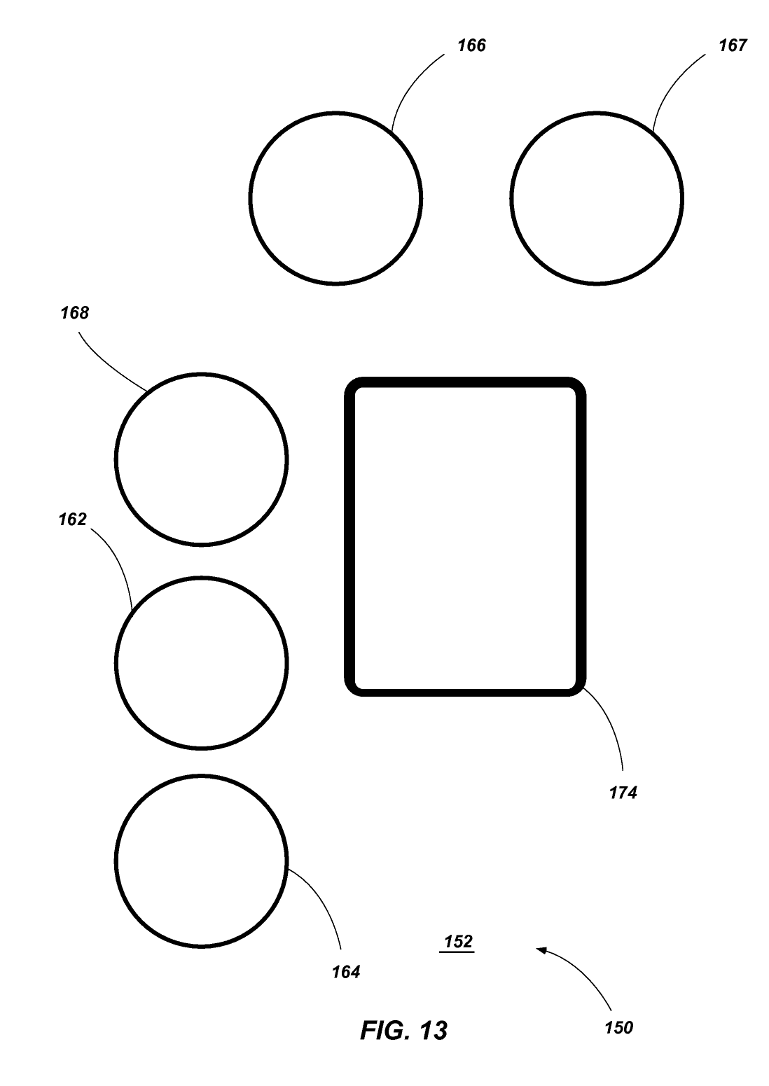

In some embodiments, and as shown in FIG. 13, each player area 152 of the gaming table surface 150 may have yet a differing layout from that depicted in FIGS. 2, 3, and 12. For example, each player area 152 may include multiple trade wager areas (e.g., trade wager areas 166 and 167) enabling the player to designate a specific card with which to trade by placing the trade wager in the trade wager area 166, 167 corresponding to the selected card as discussed above. As above, each player area 152 of the gaming table surface 150 may include the ante wager area 162, the raise wager area 164, the trade wager area 166, and the player card area 174.

Referring back to FIGS. 2 and 3, in administering a round of the wagering game, a mandatory ante wager, at least partially covering placed the ante wager area 162, may be accepted from a player. The dealer may also accept a wager in the bonus wager area 168 if the player wished to participate in, e.g., the 3 Card Bonus® wager or r other type of bonus wager.

Dealer cards (e.g., two cards) may be dealt from a deck of cards to the dealer card areas 156 around which the player areas 152 are arranged. Player cards (e.g., one card per player) may be dealt from the deck of cards to a player card area 174. As discussed above, in some embodiments, more than one card (e.g., two or three cards) may be dealt to each player. In such embodiments, each player area 152 may include a corresponding amount of player card areas or one player card area sized to fit the number of cards dealt to the player. In other embodiments, the player area 152 may lack a specific player card area and cards may be provided to the player generally in the player area 152.

After the player views the player hand, an election of one or more of placing a raise wager in the raise wager area 164, placing a trade wager in the trade wager area 166, or an indication of checking (e.g., standing) may be accepted from the player. In some embodiments, the player area 152 may include player card area where the player may place their card as an indication of the player's intention to at least one of stand, raise, or trade.

If the election of placing the trade wager is accepted, the dealer may provide an additional card to the player hand. For example, the dealer may take the card from the player card area 174 and provide another card to the player hand at the player card area 174 (e.g., from the deck of cards, from one of the two dealer card areas 156, or from the player hand). If the card is provided from the dealer card areas 156, the dealer may replace the card by dealing another card from the deck to the two dealer card areas 156. As discussed above, in some embodiments, each player area 152 may include multiple trade wager areas (e.g., two trade wager areas) that correspond to specific cards in the dealer or player hand. That is, the player may select which card the player wants to receive by placing the trade wager in the trade wager area corresponding to the desired card in the dealer or player hand. In some embodiments, the gaming table surface 150 may include another playing card area into which the card of the player hand can be moved if the player wants to trade that card.

As discussed above, in some embodiments, the raise wager in the raise wager area 164 may be accepted after the trade wager has been placed in the trade wager area 166.

The cards in the two dealer card areas 156 are exposed to the player. As mentioned above, the dealer may select the card having the higher rank to be compared to the card in each player card area 174. In some embodiments, the gaming table surface 150 may include additional indicia (e.g., rectangle) where the higher ranked card of the dealer may be moved to and displayed.

The wagers are then resolved, as described above, and according to the paytables 170, 172, e.g., as displayed on the gaming table surface 150.

In some embodiments, the wagering games described herein may be played against a game administrator (i.e., against “the house” such that the game is “house-banked”). Such implementations may involve the game administrator (e.g., a casino or other gaming establishment) accepting (e.g., via a dealer or other agent of the administrator) wagers of real-world monetary value, distributing payouts of real-world monetary value on winning wagers to players, and collecting real-world monetary value of lost wagers. Such “house-banked” embodiments may be implemented, for example, in the form of a live table game, in a virtual table game, in an electronic game, or in a networked (e.g., Internet) game configuration.

For example, and referring to FIGS. 2 and 3, the casino or other gaming establishment, acting as the dealer, may accept an ante wager from each player, which may be reflected by the presence of a chip or an image of a chip in the ante wager area 162 in the player position 152 of each participating player. The dealer may also accept a bonus wager from at least one player, which may be reflected by the presence of a chip or an image of a chip in the bonus wager area 168.

The dealer may deal one card (e.g., physical playing cards from a deck or multiple intermixed decks of playing cards, such as a standard deck, virtual playing cards, or combinations thereof) to each player and two cards to the dealer, which may be reflected by the presence of cards or images of cards in the area 174 of each player position 152 and in the area 156 of the dealer position 154. The dealer may accept from each player, in turn, a decision to one or more of stand, an election to raise, and trade one or more cards. The dealer may also accept a raise wager along with the election to raise and a trade wager along with the election to trade from at least one player, which may be reflected by the presence of a chip or an image of a chip in the raise wager area 164 and the trade wager area 166. When the dealer accepts a player's decision to stand, the dealer may refrain from dealing additional cards to the area 174 of that player's player position 152. When the dealer accepts a player's election to trade, the dealer may provide one or more replacement cards to the area 174 of that player's player position 152.

The dealer may resolve the ante wager, the raise wager, and the trade wager by comparing the rank of the player's hand to the rank of the dealer's hand, as discussed above, with the dealer paying winning wagers, retaining losing wagers, and returning pushed wagers. The dealer may resolve the bonus wager based on cards from the player hand and/or the dealer hand. Such “house-banked” embodiments may be implemented in the form of a live table game, in a virtual table game, in an electronic game, or in an online game configuration.

In other embodiments, the wagering games, or at least one wager associated with the wagering games, may involve a player in a casino or other gaming establishment acting as banker, accepting wagers having real-world monetary value, issuing payouts having real-world monetary value, and collecting real-world monetary value of lost wagers (i.e., be “player-banked”). In some embodiments where at least one wager is player-banked, the game administrator may collect a player entrance fee, or a rake on each player-banked wager accepted from the participating players, including the banker.

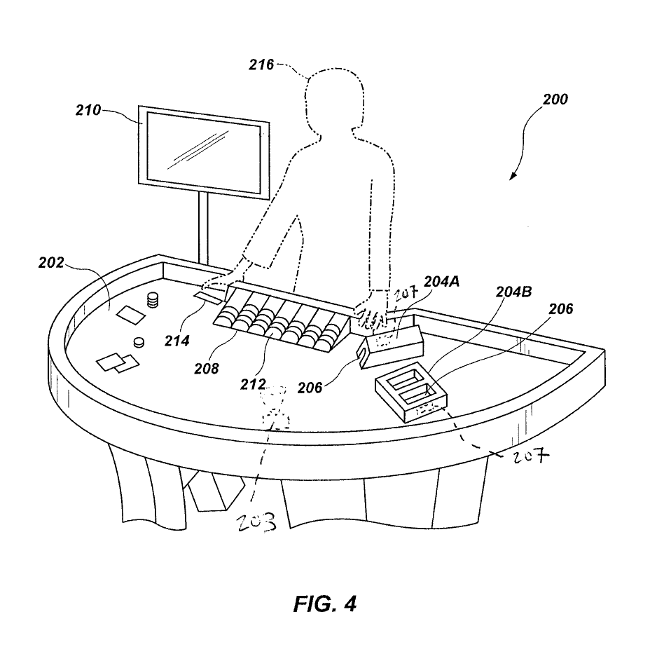

FIG. 4 is a perspective view of an embodiment of a gaming table 200 for implementing wagering games in accordance with this disclosure. The gaming table 200 may be a physical article of furniture around which participants in the wagering game may stand or sit and on which the physical objects used for administering and otherwise participating in the wagering game may be supported, positioned, moved, transferred, and otherwise manipulated. For example, the gaming table 200 may include a gaming surface 202 on which the physical objects used in administering the wagering game may be located. The gaming surface 202 may be, for example, a felt fabric covering a hard surface of the table, and a design, conventionally referred to as a “layout,” specific to the game being administered may be physically printed on the gaming surface 202. As another example, the gaming surface 202 may be a surface of a transparent or translucent material (e.g., glass or plexiglass) onto which a projector 203, which may be located, for example, above or below the gaming surface 202, may illuminate a layout specific to the wagering game being administered. In such an example, the specific layout projected onto the gaming surface 202 may be changeable, enabling the gaming table 200 to be used to administer different variations of wagering games within the scope of this disclosure or other wagering games. Additional details of illustrative gaming surfaces and projectors are disclosed in U.S. patent application Ser. No. 13/919,849, filed Jun. 17, 2013, and titled “ELECTRONIC GAMING DISPLAYS, GAMING TABLES INCLUDING ELECTRONIC GAMING DISPLAYS AND RELATED ASSEMBLIES, SYSTEMS AND METHODS,” the disclosure of which is incorporated herein in its entirety by this reference. In either example, the gaming surface 202 may include, for example, designated areas for player positions; areas in which one or more of player cards, dealer cards, or community cards may be dealt; areas in which wagers may be accepted; areas in which wagers may be grouped into pots; and areas in which rules, pay tables, and other instructions related to the wagering game may be displayed. As a specific, nonlimiting example, the gaming surface 202 may be configured as shown in FIGS. 2 and 3.

In some embodiments, the gaming table 200 may include a display 210 separate from the gaming surface 202. The display 210 may be configured to face players, prospective players, and spectators and may display, for example, rules, paytables, real-time game status, such as wagers accepted and cards dealt, historical game information, such as amounts won, amounts wagered, percentage of hands won, and notable hands achieved, and other instructions and information related to the wagering game. The display 210 may be a physically fixed display, such as a poster, in some embodiments. In other embodiments, the display 210 may change automatically in response to a stimulus (e.g., may be an electronic video monitor).

The gaming table 200 may include particular machines and apparatuses configured to facilitate the administration of the wagering game. For example, the gaming table 200 may include one or more card-handling devices 204. The card-handling device 204A may be, for example, a shoe from which physical cards 206 from one or more decks of playing cards may be withdrawn, one at a time. Such a card-handling device 204A may include a housing in which cards 206 are located, an opening from which cards 206 are removed, and a card-presenting mechanism (e.g., a moving weight on a ramp configured to push a stack of cards down the ramp) configured to continually present new cards 206 for withdrawal from the shoe. Additional details of an illustrative card-handling device 204A configured as a shoe are found in U.S. Patent App. Pub. No. 2010/0038849, published Feb. 18, 2010, and titled “INTELLIGENT AUTOMATIC SHOE AND CARTRIDGE,” the disclosure of which is incorporated herein in its entirety by this reference. The card-handling device 204B may be, for example, a shuffler configured to reorder physical cards 206 from one or more decks of playing cards and present randomized cards 206 for use in the wagering game. Such a card-handling device 204B may include a housing, a shuffling mechanism configured to shuffle cards, and card inputs and outputs (e.g., trays). Additional details of an illustrative card-handling device 204B configured as a shuffler are found in U.S. Pat. No. 8,070,574, issued Dec. 6, 2011, to Grauzer et al., the disclosure of which is incorporated herein in its entirety by this reference. The card-handling device 204 may also be, for example, a combination shuffler and shoe in which the output for the shuffler is a shoe. The card-handling device 204 may simply be supported on the gaming surface 202 in some embodiments. In other embodiments, the card-handling device 204 may be mounted into the gaming table 202 such that the card-handling device 204 is not manually removable from the gaming table 202 without the use of tools. In some embodiments, the deck or decks of playing cards used may be standard, 52-card decks. In other embodiments, the deck or decks used may include cards, such as, for example, jokers, wild cards, bonus cards, etc.

In some embodiments, the card-handling device 204 may include an electronic display 207 for displaying information related to the wagering game being administered. For example, the electronic display 207 may display a menu of game options, the game selected, the number of cards per hand to be dispensed, acceptable amounts for wagers (e.g., maximums and minimums), numbers of cards to be dealt to recipients, locations of particular recipients for particular cards, winning and losing wagers, pay tables, and payout amounts. In other embodiments, information related to the wagering game may be displayed on another electronic display, such as, for example, the display 210 described previously.

The type of card-handling device 204 employed to administer embodiments of the disclosed wagering game, as well as the type of card deck employed and the number of decks, may be specific the game to be implemented. For example, the card-handling device 206 may include a shuffler, a shoe, or combinations thereof. Such shufflers and/or shoes may be implemented with one or more decks (e.g., six combined decks, eight combined decks) at a time. In some embodiments, a shuffler/shoe combination that deals complete hands to each player at a time may be utilized.

The gaming table 200 may include one or more chip racks 208 configured to facilitate accepting wagers, transferring lost wagers to the house, and exchanging monetary value for wagering elements 212 (e.g., chips). For example, the chip rack 208 may include a series of token support rows, each of which may support tokens of a different type (e.g., color and denomination). In some embodiments, the chip rack 208 may be configured to automatically present a selected number of chips using a chip-cutting-and-delivery mechanism. Additional details of an illustrative chip rack 208 and chip-cutting-and-delivery mechanism are found in U.S. Pat. No. 7,934,980, issued May 3, 2011, to Blaha et al., the disclosure of which is incorporated herein in its entirety by this reference. In some embodiments, the gaming table 200 may include a drop box 214 for money that is accepted in exchange for wagering elements 212. The drop box 214 may be, for example, a secure container (e.g., a safe or lockbox) having a one-way opening into which money may be inserted and a secure, lockable opening from which money may be retrieved. Such drop boxes 214 are known in the art and may be incorporated directly into the gaming table 200 and may, in some embodiments, have a removable container for the retrieval of money in a separate, secure location.

When administering a wagering game in accordance with embodiments of this disclosure, a dealer 216 may receive money (e.g., cash) from a player in exchange for wagering elements 212. The dealer 216 may deposit the money in the deposit 214 and transfer physical wagering elements 212 to the player. The dealer 216 may accept one or more initial wagers (e.g., antes and other wagers) from the player, which may be reflected by the dealer 216 permitting the player to place one or more wagering tokens 212 or other wagering elements (e.g., cash) within designated areas on the gaming surface 202 associated with the various wagers of the wagering game. Once initial wagers have been accepted, the dealer 216 may remove physical cards 206 from the card-handling device 204 and position them within designated areas on the gaming surface 202, which may designate the cards 206 for use as individual player cards, community cards, or dealer cards in accordance with game rules.

After dealing the cards 206, and during play, according to the game rules, any additional wagers (e.g., play bets) may be accepted, which may be reflected by the dealer 216 permitting the player to place one or more wagering tokens 212 within designated areas on the gaming surface 202 associated with the various wagers of the wagering game. In some embodiments, a player may fold, which may result in the dealer 216 collecting at least one of the wagering tokens 212 from that player and transferring it to the house, which may be reflected by the wagering token 212 being returned to the chip rack 208. The dealer 216 may perform any additional card dealing and rounds of betting permitted in the wagering game. Finally, the dealer 216 may resolve the wagers, award winning wagers to the players, which may be accomplished by giving wagering tokens 212 from the chip rack 208 to the players, and transferring losing wagers to the house, which may be accomplished by moving wagering tokens 212 from the players to the chip rack 208.

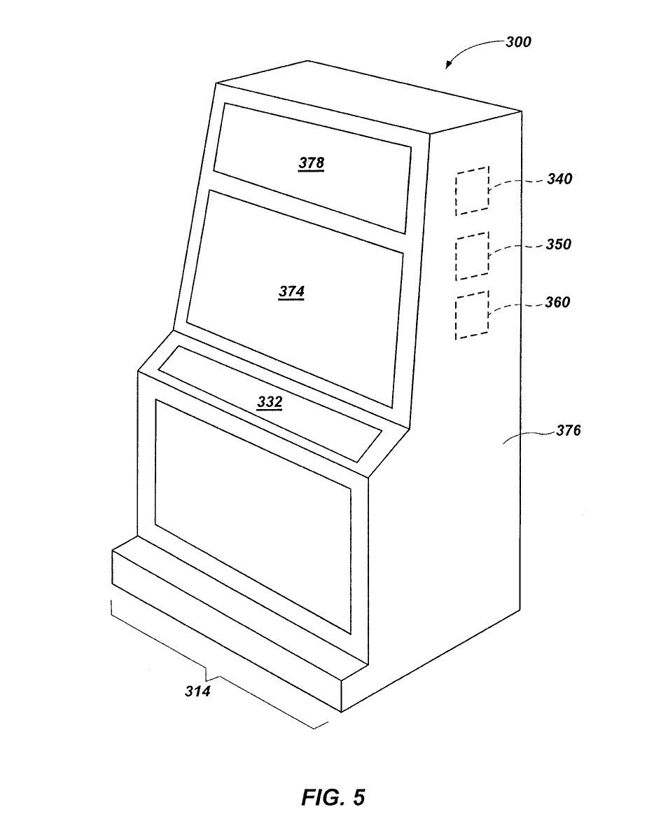

FIG. 5 is a perspective view of an individual electronic gaming device 300 (e.g., an electronic gaming machine (EGM)) configured for implementing wagering games according to this disclosure. The individual electronic gaming device 300 may include an individual player position 314 including a player input area 332 configured to enable a player to interact with the individual electronic gaming device 300 through various input devices (e.g., buttons, levers, touchscreens). The individual electronic gaming device 300 may include a gaming screen 374 configured to display indicia for interacting with the individual electronic gaming device 300, such as through processing one or more programs stored in memory 340 to implement the rules of game play at the individual electronic gaming device 300. Accordingly, game play may be accommodated without involving physical playing cards, chips or other wagering elements, and live personnel. The action may instead be simulated by a control processor 350 operably coupled to the memory 340 and interacting with and controlling the individual electronic gaming device 300.

Although the individual electronic gaming device 300 displayed in FIG. 5 has an outline of a traditional gaming cabinet, the individual electronic gaming device 300 may be implemented in other ways, such as, for example, client software downloaded to a portable device, such as a smart phone, tablet, or laptop computer. The individual electronic gaming device 300 may also be a non-portable personal computer (e.g., a desktop or all-in-one computer) or other computing device. In some embodiments, client software is not downloaded but is native to the device or is otherwise delivered with the device when distributed.

A communication device 360 may be included and operably coupled to the processor 350 such that information related to operation of the individual electronic gaming device 300, information related to the game play, or combinations thereof may be communicated between the individual electronic gaming device 300 and other devices such as a server through a suitable communication medium, such, as, for example, wired networks, Wi-Fi networks, and cellular communication networks.

The gaming screen 374 may be carried by a generally vertically extending cabinet 376 of the individual electronic gaming device 300. The individual electronic gaming device 300 may further include banners to communicate rules of game play and the like, such as along a top portion 378 of the cabinet 376 of the individual electronic gaming device 300. The individual electronic gaming device 300 may further include additional decorative lights (not shown), and speakers (not shown) for transmitting and optionally receiving sounds during game play. Further detail of an example of an individual electronic gaming device 300 (as well as other embodiments of tables and devices) is disclosed in U.S. patent application Ser. No. 13/963,165, filed Aug. 9, 2013, and titled “METHODS AND SYSTEMS FOR ELECTRONIC GAMING” the disclosure of which is incorporated herein in its entirety by this reference.

Some embodiments may be implemented at locations including a plurality of player stations. Such player stations may include an electronic display screen for display of game information (e.g., cards, wagers, and game instructions) and for accepting wagers and facilitating credit balance adjustments. Such player stations may, optionally, be integrated in a table format, may be distributed throughout a casino or other gaming site, or may include both grouped and distributed player stations.

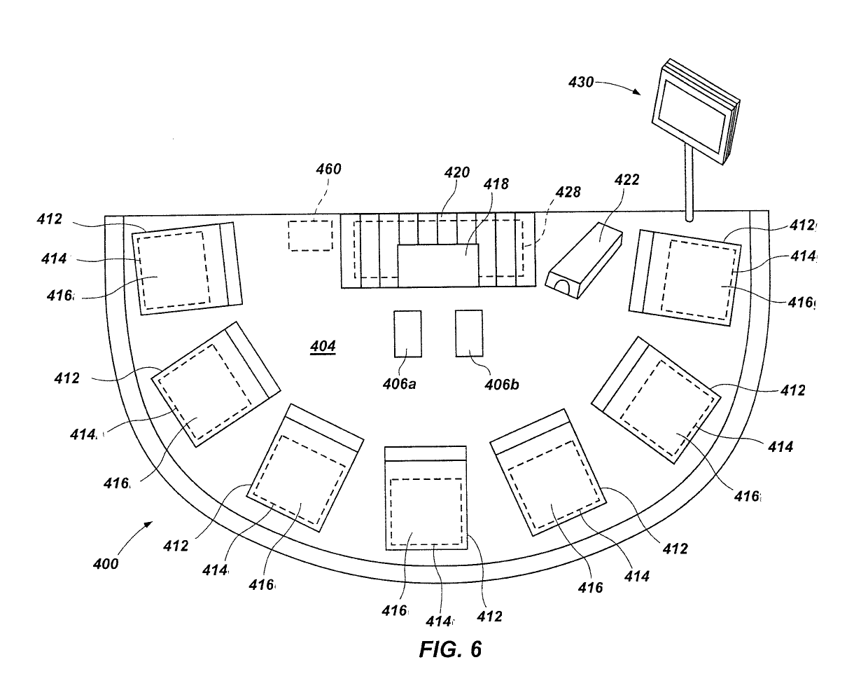

FIG. 6 is a top view of a suitable table 400 configured for implementing wagering games according to this disclosure. The table 400 may include a playing surface 404. The table 400 may include player stations 412. Each player station 412 may include a player interface 416, which may be used for displaying game information (e.g., game instructions, input options, wager information, game outcomes, etc. and accepting player elections). The player interface 416 may be a display screen in the form of a touch screen, which may be at least substantially flush with the playing surface 404 in some embodiments. Each player interface 416 may be operated by its own local game processor 414 (shown in dashed lines), although, in some embodiments, a central game processor 428 (shown in dashed lines) may be employed and may communicate directly with player interfaces 416. In some embodiments, a combination of individual local game processors 414 and the central game processor 428 may be employed.

A communication device 460 may be included and may be operably coupled to one or more of the local game processors 414, the central game processor 428, or combinations thereof, such that information related to operation of the table 400, information related to the game play, or combinations thereof may be communicated between the table 400 and other devices through a suitable communication medium, such as, for example, wired networks, Wi-Fi networks, and cellular communication networks.

The table 400 may further include additional features, such as a dealer chip tray 420, which may be used by the dealer to cash players in and out of the wagering game, whereas wagers and balance adjustments during game play may be performed using, for example, virtual chips (e.g., images or text representing wagers). For embodiments using physical cards 406a and 406b, the table 400 may further include a card-handling device 422, which may be configured to shuffle, read, and deliver physical cards for the dealer and players to use during game play or, alternatively, a card shoe configured to read and deliver cards that have already been randomized. For embodiments using virtual cards, the virtual cards may be displayed at the individual player interfaces 416. Common virtual cards may be displayed in a common card area.

The table 400 may further include a dealer interface 418, which, like the player interfaces 416, may include touch screen controls for receiving dealer inputs and for assisting the dealer in administering the wagering game. The table 400 may further include an upright display 430 configured to display images that depict game information such as pay tables, hand counts, historical win/loss information by player, and a wide variety of other information considered useful to the players. The upright display 430 may be double sided to provide such information to players as well as to casino pit personnel.

Further detail of an example of a table and player displays is disclosed in U.S. Pat. No. 8,262,475, issued Sep. 11, 2012, and titled “CHIPLESS TABLE SPLIT SCREEN FEATURE,” the disclosure of which is incorporated herein in its entirety by this reference. Although an embodiment is described showing individual discrete player stations, in some embodiments, the entire playing surface 404 may be an electronic display that is logically partitioned to permit game play from a plurality of players for receiving inputs from, and displaying game information to, the players, the dealer, or both.

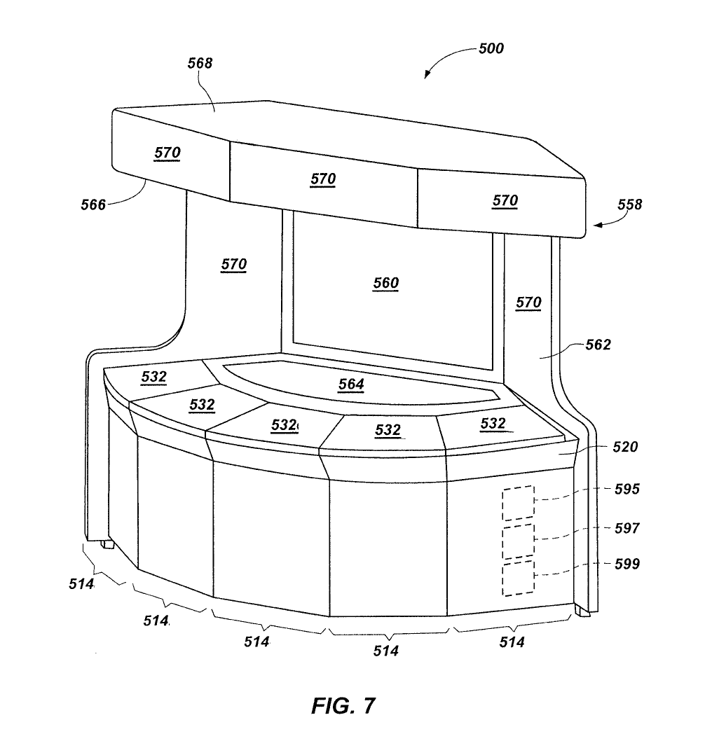

FIG. 7 is a perspective view of another embodiment of a suitable table 500 configured for implementing wagering games according to the present disclosure utilizing a virtual dealer. The table 500 may include player positions 514 arranged in a bank about an arcuate edge 520 of a video device 558 that may comprise a card screen 564 and a dealer screen 560. The dealer screen 560 may display a video simulation of the dealer (i.e., a virtual dealer) for interacting with the video device 558, such as through processing one or more stored programs stored in memory 595 to implement the rules of game play at the video device 558. The dealer screen 560 may be carried by a generally vertically extending cabinet 562 of the video device 558. The card screen 564 may be configured to display at least one or more of the dealer's cards, any community cards, and player's cards by the virtual dealer on the dealer screen 560.

Each of the player positions 514 may include a player interface area 532 configured for wagering and game play interactions with the video device 558 and virtual dealer. Accordingly, game play may be accommodated without involving physical playing cards, poker chips, and live personnel. The action may instead be simulated by a control processor 597 interacting with and controlling the video device 558. The control processor 597 may be programmed, by known techniques, to implement the rules of game play at the video device 558. As such, the control processor 597 may interact and communicate with display/input interfaces and data entry inputs for each player interface area 532 of the video device 558. Other embodiments of tables and gaming devices may include a control processor that may be similarly adapted to the specific configuration of its associated device.

A communication device 599 may be included and operably coupled to the control processor 597 such that information related to operation of the table 500, information related to the game play, or combinations thereof may be communicated between the table 500 and other devices such as a central server through a suitable communication medium, such, as, for example, wired networks, Wi-Fi networks, and cellular communication networks.

The video device 558 may further include banners communicating rules of play and the like, which may be located along one or more walls 570 of the cabinet 562. The video device 558 may further include additional decorative lights and speakers, which may be located on an underside surface 566, for example, of a generally horizontally extending top 568 of the cabinet 562 of the video device 558 generally extending toward the player positions 514.

Further detail of an example of a table and player displays is disclosed in U.S. Pat. No. 8,272,958, issued Sep. 25, 2012, and titled “AUTOMATED MULTIPLAYER GAME TABLE WITH UNIQUE IMAGE FEED OF DEALER,” the disclosure of which is incorporated herein in its entirety by this reference. Although an embodiment is described showing individual discrete player stations, in some embodiments, the entire playing surface (e.g., player interface areas 532, card screen 564, etc.) may be a unitary electronic display that is logically partitioned to permit game play from a plurality of players for receiving inputs from, and displaying game information to, the players, the dealer, or both.

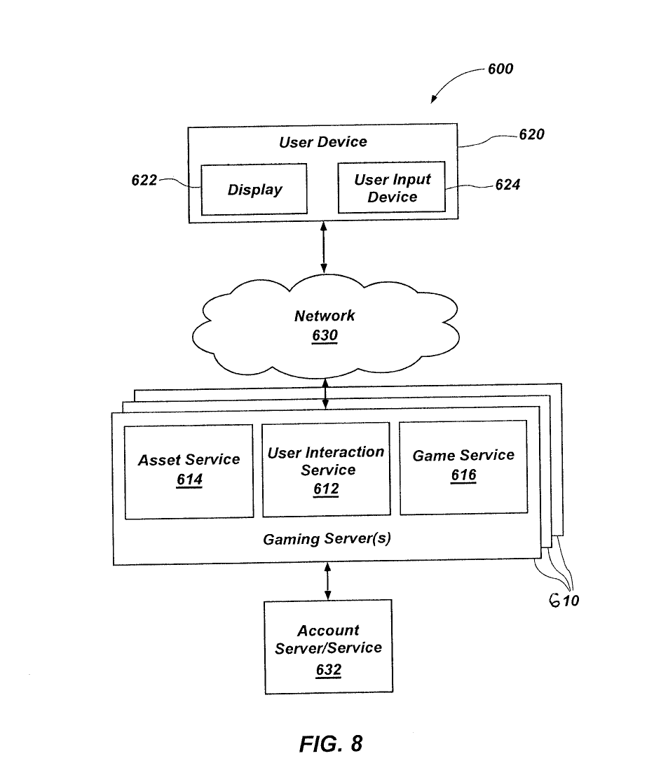

In some embodiments, wagering games in accordance with this disclosure may be administered using a gaming system employing a client-server architecture (e.g., over the Internet, a local area network, etc.). FIG. 8 is a schematic block diagram of an exemplary gaming system 600 for implementing wagering games according to this disclosure. The gaming system 600 may enable end users to remotely access game content. Such game content may include, without limitation, various types of wagering games such as card games, dice games, big wheel games, roulette, scratch off games (“scratchers”), and any other wagering game where the game outcome is determined, in whole or in part, by one or more random events. This includes, but is not limited to, Class II and Class III games as defined under 25 U.S.C. §2701 et seq. (“Indian Gaming Regulatory Act”). Such games may include banked and/or non-banked games.

The wagering games supported by the gaming system 600 may be operated with real currency or with virtual credits or other virtual (e.g., electronic) value indicia. For example, the real currency option may be used with traditional casino and lottery-type wagering games in which money or other items of value are wagered and may be cashed out at the end of a game session. The virtual credits option may be used with wagering games in which credits (or other symbols) may be issued to a player to be used for the wagers. A player may be credited with credits in any way allowed, including, but not limited to, a player purchasing credits; being awarded credits as part of a contest or a win event in this or another game (including non-wagering games); being awarded credits as a reward for use of a product, casino, or other enterprise, time played in one session, or games played; or may be as simple as being awarded virtual credits upon logging in at a particular time or with a particular frequency, etc. Although credits may be won or lost, the ability of the player to cash out credits may be controlled or prevented. In one example, credits acquired (e.g., purchased or awarded) for use in a play-for-fun game may be limited to non-monetary redemption items, awards, or credits usable in the future or for another game or gaming session. The same credit redemption restrictions may be applied to some or all of credits won in a wagering game as well.

An additional variation includes web-based sites having both play-for-fun and wagering games, including issuance of free (non-monetary) credits usable to play the play-for-fun games. This feature may attract players to the site and to the games before they engage in wagering. In some embodiments, a limited number of free or promotional credits may be issued to entice players to play the games. Another method of issuing credits includes issuing free credits in exchange for identifying friends who may want to play. In another embodiment, additional credits may be issued after a period of time has elapsed to encourage the player to resume playing the game. The gaming system 600 may enable players to buy additional game credits to allow the player to resume play. Objects of value may be awarded to play-for-fun players, which may or may not be in a direct exchange for credits. For example, a prize may be awarded or won for a highest scoring play-for-fun player during a defined time interval. All variations of credit redemption are contemplated, as desired by game designers and game hosts (the person or entity controlling the hosting systems).

The gaming system 600 may include a gaming platform to establish a portal for an end user to access a wagering game hosted by one or more gaming servers 610 over a network 630. In embodiments, games are accessed through a user interaction service 612. The gaming system 600 enables players to interact with a user device 620 through a user input device 624 and a display 622 and to communicate with one or more gaming servers 610 using a network 630 (e.g., the Internet). Typically the user device is remote from the gaming server 610 and the network is the word-wide web (i.e., internet).

In some embodiments, the gaming servers 610 may be configured as a single server to administer wagering games in combination with the user device 620. In other embodiments, the gaming servers 610 may be configured as separate servers for performing separate, dedicated functions associated with administering wagering games. Accordingly, the following description also discusses “services” with the understanding that the various services may be performed by different servers or combinations of servers in different embodiments. As shown in FIG. 8, the gaming servers 610 may include a user interaction service 612, a game service 616, and an asset service 614. In some embodiments, one or more of the gaming servers 610 may communicate with an account server 632 performing an account service 632. As explained more fully below, for some wagering type games, the account service 632 may be separate and operated by a different entity than the gaming servers 610; however, in some embodiments the account service 632 may also be operated one or more of the gaming servers 610.

The user device 620 may communicate with the user interaction service 612 through the network 630. The user interaction service 612 may communicate with the game service 616 and provide game information to the user device 620. In some embodiments, the game service 616 may also include a game engine. The game engine may comprise game rules. In some embodiments, a single user device 620 communicates with a game provided by the game service 616, while other embodiments may include a plurality of user devices 620 configured to communicate and provide end users with access to the same game provided by the game service 616. In addition, a plurality of end users may be permitted to access a single user interaction service 612, or a plurality of user interaction services 612, to access the game service 616. The user interaction service 612 may enable a user to create and access a user account and interact with game service 616. The user interaction service 612 may enable users to initiate new games, join existing games, and interface with games being played by the user.

The user interaction service 612 may also provide a client for execution on the user device 620 for accessing the gaming servers 610. The client provided by the gaming servers 610 for execution on the user device 620 may be any of a variety of implementations depending on the user device 620 and method of communication with the gaming servers 610. In one embodiment, the user device 620 may connect to the gaming servers 610 using a web browser, and the client may execute within a browser window or frame of the web browser. In another embodiment, the client may be a stand-alone executable on the user device 620.

For example, the client may comprise a relatively small amount of script (e.g., JAVASCRIPT®), also referred to as a “script driver,” including scripting language that controls an interface of the client. The script driver may include simple function calls requesting information from the gaming servers 610. In other words, the script driver stored in the client may merely include calls to functions that are externally defined by, and executed by, the gaming servers 610. As a result, the client may be characterized as a “thin client.” The client may simply send requests to the gaming servers 610 rather than performing logic itself. The client may receive player inputs, and the player inputs may be passed to the gaming servers 610 for processing and executing the wagering game. In some embodiments, this may involve providing specific graphical display information for the display 622 as well as game outcomes.

As another example, the client may comprise an executable file rather than a script. The client may do more local processing than does a script driver, such as calculating where to show what game symbols upon receiving a game outcome from the game service 616 through user interaction service 612. In some embodiments, portions of an asset service 614 may be loaded onto the client and may be used by the client in processing and updating graphical displays. Some form of data protection, such as end-to-end encryption, may be used when data is transported over the network 630. The network 630 may be any network, such as, for example, the Internet or a local area network.

The gaming servers 610 may include an asset service 614, which may host various media assets (e.g., text, audio, video, and image files) to send to the user device 620 for presenting the various wagering games to the end user. In other words, the assets presented to the end user may be stored separately from the user device 620. For example, the user device 620 requests the assets appropriate for the game played by the user; as another example, especially relating to thin clients, just those assets that are needed for a particular display event will be sent by the gaming servers 610, including as few as one asset. The user device 620 may call a function defined at the user interaction service 612 or asset service 614, which may determine which assets are to be delivered to the user device 620 as well as how the assets are to be presented by the user device 620 to the end user. Different assets may correspond to the various user devices 620 and their clients that may have access to the game service 616 and to different variations of wagering games.

The gaming servers 610 may include the game service 616, which may be programmed to administer wagering games and determine game play outcomes to provide to the user interaction service 612 for transmission to the user device 620. For example, the game service 616 may include game rules for one or more wagering games, such that the game service 616 controls some or all of the game flow for a selected wagering game as well as the determined game outcomes. The game service 616 may include pay tables and other game logic. The game service 616 may perform random number generation for determining random game elements of the wagering game. In one embodiment, the game service 616 may be separated from the user interaction service 612 by a firewall or other method of preventing unauthorized access to the game service 612 by the general members of the network 630.

The user device 620 may present a gaming interface to the player and communicate the user interaction from the user input device 624 to the gaming servers 610. The user device 620 may be any electronic system capable of displaying gaming information, receiving user input, and communicating the user input to the gaming servers 610. For example, the user device 620 may be a desktop computer, a laptop, a tablet computer, a set-top box, a mobile device (e.g., a smartphone), a kiosk, a terminal, or another computing device. As a specific, nonlimiting example, the user device 620 operating the client may be an interactive electronic gaming system 300 (see FIG. 5), as described above. The client may be a specialized application or may be executed within a generalized application capable of interpreting instructions from an interactive gaming system, such as a web browser.

The client may interface with an end user through a web page or an application that runs on a device including, but not limited to, a smartphone, a tablet, or a general computer, or the client may be any other computer program configurable to access the gaming servers 610. The client may be illustrated within a casino webpage (or other interface) indicating that the client is embedded into a webpage, which is supported by a web browser executing on the user device 620.

In some embodiments, components of the gaming system 600 may be operated by different entities. For example, the user device 620 may be operated by a third party, such as a casino or an individual, that links to the gaming servers 610, which may be operated, for example, by a wagering game service provider. Therefore, in some embodiments, the user device 620 and client may be operated by a different administrator than the operator of the game service 616. In other words, the user device 620 may be part of a third-party system that does not administer or otherwise control the gaming servers 610 or game service 616. In other embodiments, the user interaction service 612 and asset service 614 may be operated by a third-party system. For example, a gaming entity (e.g., a casino) may operate the user interaction service 612, user device 620, or combination thereof to provide its customers access to game content managed by a different entity that may control the game service 616, amongst other functionality. In still other embodiments, all functions may be operated by the same administrator. For example, a gaming entity (e.g., a casino) may elect to perform each of these functions in-house, such as providing access to the user device 620, delivering the actual game content, and administering the gaming system 600.

The gaming servers 610 may communicate with one or more external account servers 632 (also referred to herein as an account service 632), optionally through another firewall. For example, the gaming servers 610 may not directly accept wagers or issue payouts. That is, the gaming servers 610 may facilitate online casino gaming but may not be part of a self-contained online casino itself. Another entity (e.g., a casino or any account holder or financial system of record) may operate and maintain its external account service 632 to accept bets and make payout distributions. The gaming servers 610 may communicate with the account service 632 to verify the existence of funds for wagering and to instruct the account service 632 to execute debits and credits. As another example, the gaming servers 610 may directly accept bets and make payout distributions, such as in the case where an administrator of the gaming servers 610 operates as a casino.

Additional features may be supported by the gaming servers 610, such as hacking and cheating detection, data storage and archival, metrics generation, messages generation, output formatting for different end user devices, as well as other features and operations. For example, the gaming servers 610 may include additional features and configurations as described in U.S. patent application Ser. No. 13/353,194, filed Jan. 18, 2012, and U.S. patent application Ser. No. 13/609,031, filed Sep. 10, 2012, both applications titled “NETWORK GAMING ARCHITECTURE, GAMING SYSTEMS, AND RELATED METHODS,” the disclosure of each of which is incorporated herein in its entirety by this reference.

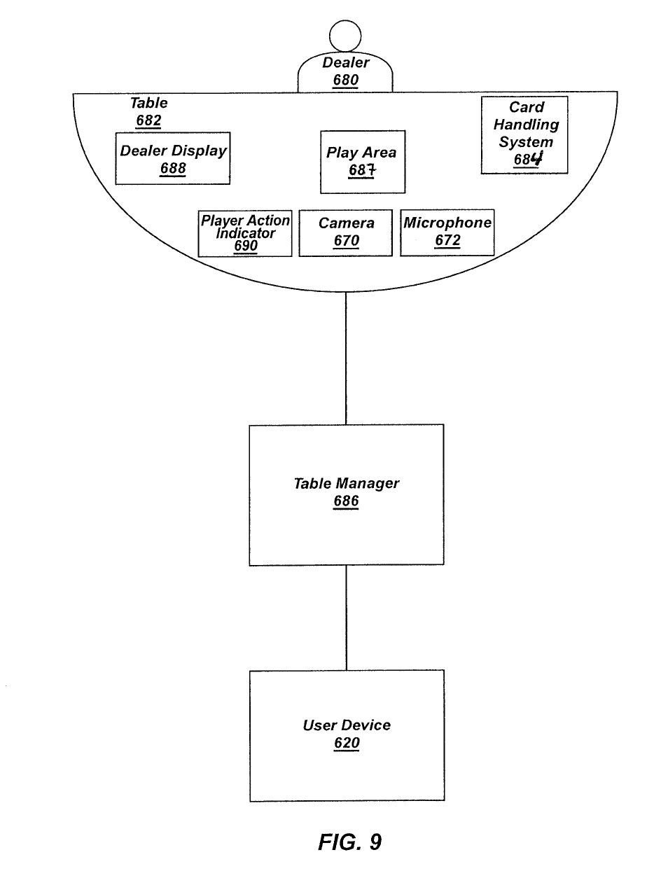

FIG. 9 is a schematic block diagram of a table 682 for implementing wagering games including a live dealer feed. Features of the gaming system 600 (see FIG. 8) described above in connection with FIG. 8 may be utilized in connection with this embodiment, except as further described. Rather than cards being determined by a computerized random processes, physical cards (e.g., from a standard, 52-card deck of playing cards) may be dealt by a live dealer 680 at a table 682 from a card handling system 684. A table manager 686 may assist the dealer 680 in facilitating play of the game by transmitting a video feed of the dealer's actions to the user device 620 and transmitting player elections to the dealer 680. As described above, the table manager 686 may act as or communicate with a gaming system 600 (see FIG. 8) (e.g., acting as the gaming system 600 (see FIG. 8) itself or as an intermediate client interposed between and operationally connected to the user device 620 and the gaming system 600 (see FIG. 8)) to provide gaming at the table 682 to users of the gaming system 600 (see FIG. 8). Thus, the table manager 686 may communicate with the user device 620 through a network 630 (see FIG. 8), and may be a part of a larger online casino, or may be operated as a separate system facilitating game play. In various embodiments, each table 682 may be managed by an individual table manager 686 constituting a gaming device, which may receive and process information relating to that table. For simplicity of description, these functions are described as being performed by the table manager 686, though certain functions may be performed by an intermediary gaming system 600 (see FIG. 8), such as the one shown and described in connection with FIG. 8. In some embodiments, the gaming system 600 (see FIG. 8) may match remotely located players to tables 682 and facilitate transfer of information between user devices 620 and tables 682, such as wagering amounts and player option elections, without managing gameplay at individual tables. In other embodiments, functions of the table manager 686 may be incorporated into a gaming system 600 (see FIG. 8).

The table 682 includes a camera 670 and optionally a microphone 672 to capture video and audio feeds relating to the table 682. The camera 670 may be trained on the dealer 680, play area 687, and card handling system 684. As the game is administered by the dealer 680, the video feed captured by the camera 670 may be shown to the player using the user device 620, and any audio captured by the microphone 672 may be played to the player using the user device 620. In some embodiments, the user device 620 may also include a camera, microphone, or both, which may also capture feeds to be shared with the dealer 680 and other players. In some embodiments, the camera 670 may be trained to capture images of the card faces, chips, and chip stacks on the surface of the gaming table. Known image extraction techniques may be used to obtain card count and card rank and suit information from the card images. An example of suitable image extraction software is disclosed in U.S. Pat. No. 7,901,285, issued Mar. 8, 2011, to Tran et al., the disclosure of which is incorporated in this disclosure in its entirety by this reference.

Card and wager data in some embodiments may be used by the table manger 686 to determine game outcome. The data extracted from the camera 670 may be used to confirm the card data obtained from the card handling system 684, to determine a player position that received a card, and for general security monitoring purposes, such as detecting player or dealer card switching, for example. Examples of card data include: suit and rank information of a hand, and suit and rank data of every hand in a round of play.

The live video feed permits the dealer to show cards dealt by the card handling system and play the game as though the player were at a live casino. In addition, the dealer can prompt a user by announcing a player's election is to be performed. In embodiments where a microphone 672 is included, the dealer 680 can verbally announce action or request an election by a player. In some embodiments, the user device 620 also includes a camera or microphone, which also captures feeds to be shared with the dealer 680 and other players.

The card handling system 684 may be as shown and described previously in connection with FIG. 4. The play area 686 depicts player positions for playing the game, such as shown in FIGS. 2 and 3. As determined by the rules of the game, the player at the user device 620 may be presented options for responding to an event in the game using a client as described with reference to FIG. 8.

Player elections may be transmitted to the table manager 686, which may display player elections to the dealer 680 using a dealer display 688 and player action indicator 690 on the table 682. For example, the dealer display 688 may display information regarding where to deal the next card or which player position is responsible for the next action.

In some embodiments, the table manager 686 may receive card information from the card handling system 684 to identify cards dealt by the card handling system 684. For example, the card handling system 684 may include a card reader to determine card information from the cards. The card information may include the rank and suit of each dealt card, and/or hand information.

The table manager 686 may apply game rules to the card information, along with the accepted player decisions, to determine gameplay events and wager results. Alternatively, the wager results may be determined by the dealer 680 and input to the table manager 686, which may be used to confirm automatically determined results by the gaming system.

Card and wager data in some embodiments may be used by the table manger 686 to determine game outcome. The data extracted from the camera 670 may be used to confirm the card data obtained from the card handling system 684, to determine a player position that received a card, and for general security monitoring purposes, such as detecting player or dealer card switching, for example.

The live video feed permits the dealer to show cards dealt by the card handling system and play the game as though the player were at a live casino. In addition, the dealer can prompt a user by announcing a player's election is to be performed. In embodiments where a microphone 672 is included, the dealer 680 can verbally announce action or request an election by a player. In some embodiments, the user device 620 also includes a camera or microphone, which also captures feeds to be shared with the dealer 680 and other players.

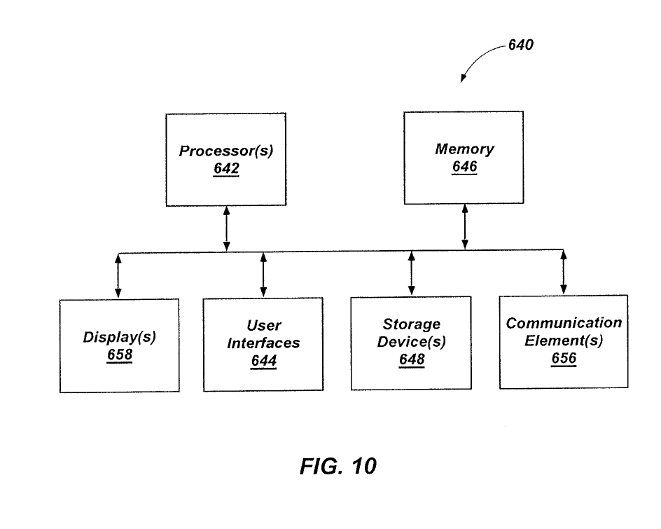

FIG. 10 is a simplified block diagram showing elements of computing devices that may be used in systems and apparatuses of this disclosure. The computing system 640 may be a user-type computer, a file server, a computer server, a notebook computer, a tablet, a handheld device, a mobile device, or other similar computer system for executing software. The computing system 640 may be configured to execute software programs containing computing instructions and may include one or more processors 642, memory 646, one or more displays 658, one or more user interface elements 644, one or more communication elements 656, and one or more storage devices 648 (also referred to herein simply as storage 648).

The processors 642 may be configured to execute a wide variety of operating systems and applications including the computing instructions for administering wagering games of the present disclosure.

The memory 646 may be used to hold computing instructions, data, and other information for performing a wide variety of tasks including administering wagering games of the present disclosure. By way of example, and not limitation, the memory 646 may include Synchronous Random Access Memory (SRAM), Dynamic RAM (DRAM), Read-Only Memory (ROM), Flash memory, and the like.

The display 658 may be a wide variety of displays such as, for example, light emitting diode displays, liquid crystal displays, cathode ray tubes, and the like. In addition, the display 658 may be configured with a touch-screen feature for accepting user input as a user interface element 644.

As non-limiting examples, the user interface elements 644 may include elements such as displays, keyboards, push buttons, mice, joysticks, haptic devices, microphones, speakers, cameras, and touchscreens.

As non-limiting examples, the communication elements 656 may be configured for communicating with other devices or communication networks. As non-limiting examples, the communication elements 656 may include elements for communicating on wired and wireless communication media, such as for example, serial ports, parallel ports, Ethernet connections, universal serial bus (USB) connections, IEEE 1394 (“firewire”) connections, Thunderbolt™ connections, Bluetooth® wireless networks, ZigBee wireless networks, 802.11 type wireless networks, cellular telephone/data networks, and other suitable communication interfaces and protocols.

The storage 648 may be used for storing relatively large amounts of nonvolatile information for use in the computing system 640 and may be configured as one or more storage devices. By way of example, and not limitation, these storage devices may include computer-readable media (CRM). This CRM may include, but is not limited to, magnetic and optical storage devices such as disk drives, magnetic tape, CDs (compact discs), DVDs (digital versatile discs or digital video discs), and semiconductor devices such as RAM, DRAM, ROM, EPROM, Flash memory, and other equivalent storage devices.

A person of ordinary skill in the art will recognize that the computing system 640 may be configured in many different ways with different types of interconnecting buses between the various elements. Moreover, the various elements may be subdivided physically, functionally, or a combination thereof. As one nonlimiting example, the memory 646 may be divided into cache memory, graphics memory, and main memory. Each of these memories may communicate directly or indirectly with the one or more processors 642 on separate buses, partially-combined buses, or a common bus.

In some embodiments, wagering games may be administered without players risking money in connection with the wagers (i.e., “play-for-fun” games). Access to play-for-fun wagering games may be granted on a time period basis in some embodiments. For example, upon initially joining the wagering game, each player may automatically be given non-monetary wagering elements, such as, for example, chips, points, or simulated currency, that are of no redeemable value. After joining, the player may be permitted to place bets using the wagering elements and a timer may track how long the player has been participating in the wagering game. If the player exhausts his or her supply of the wagering elements before a predetermined period of time has expired, the player may be permitted to simply wait until the period of time passes to rejoin the game, at which time access to another quantity of the wagering elements may be granted to the player to permit the player to resume participation in the wagering game.

In some embodiments, a hierarchy of players may determine the quantity of wagering elements given to a player for each predetermined period of time. For example, players who have been participating in the wagering game for a longer time, who have played closest to optimal strategy for the game, who have won the largest percentage of wagers, who have wagered the most in a play-for-pay environment, or who have won the largest quantities of wagering elements from their wagers may be given more wagering elements for each allotment of time than players who have newly joined, who have played according to poor strategy, who have lost more frequently, or who have lost larger quantities of wagering elements. In some embodiments, the hierarchy of players may determine the duration of each allotment of time. For example, players who have been participating in the wagering game for a longer time, who have played closest to optimal strategy for the game, who have won the largest percentage of wagers, or who have won the largest quantities of wagering elements from their wagers may be given shorter allotments of times to wait for an award of more wagering elements than players who have newly joined, who have played according to poor strategy, who have lost more frequently, or who have lost larger quantities of wagering elements. In some embodiments, players who have not run out of wagering elements after the period of time has expired may have the balance of their wagering elements reset for a subsequent allotment of time. In other embodiments, players who have not run out of wagering elements may be allowed to retain their remaining wagering elements for subsequent allotments of time, and may be given additional wagering elements corresponding to the new allotment of time to further increase the balance of wagering elements at their disposal. Players may be assigned to different categories of players, which determine the number of wagering elements awarded. In a given period of time, higher level players, or players who have invested more time playing the game may be allotted more wagering elements per unit of time than a player assigned to a lower level group.

Therefore, in some embodiments, the wagering game may be administered by receiving wagers (e.g., ante, raise, trade, and bonus wagers) of no real-world monetary value, and payouts may be paid without transferring real-world monetary value to the players. Such embodiments, referred to herein as “free play-for-fun” embodiments are nonetheless contemplated as modes of carrying out the methods described herein.

In some embodiments, referred to herein as “social play-for-fun” embodiments, a player may be permitted to redeem an access token of no redeemable face value, such as, for example, points associated with a player account (e.g., social media account credits, online points associated with a transacting account, etc.), to compress the period of time and receive more wagering elements. The access tokens may be sold or may be given without directly exchanging money for the access tokens. For example, access tokens may be allocated to players who participate in member events (e.g., complete surveys, receive training on how to play the wagering game, share information about the wagering game with others), spend time participating in the wagering game or in a player account forum (e.g., logged in to a social media account), or view advertising. Thus, an entity administering social play-for-fun wagering games may not receive money from losing player wagers or may not take a rake on wagers, but may receive compensation through advertising revenue or through the purchase of access tokens redeemable for time compressions to continue play of the wagering game or simply to increase the quantity of wagering elements available to a player.

After receipt of an indication that a player has stopped participating in a play-for-fun wagering game (e.g., a free play-for-fun embodiment, a social play-for-fun embodiment), any remaining quantities of the wagering elements may be relinquished by the player and retained by the administrator, in some embodiments. For example, receipt of an indication that the player has logged out of a play-for-fun wagering game administered over the Internet may cause any remaining wagering elements associated with a respective player to be lost. Thus, when the player rejoins the play-for-fun wagering game, the quantity of wagering elements given to the player for an allotment of time may not bear any relationship to the quantity of wagering elements held by the player when he or she quit playing a previous session of the wagering game. In other embodiments, upon receipt of an indication that a player has stopped playing, the quantity of wagering elements held by the player at that time may be retained and made available to the player, along with any additional quantities of wagering elements granted for new allotments of time, upon receipt of an indication that the player has rejoined the wagering game.

### Example

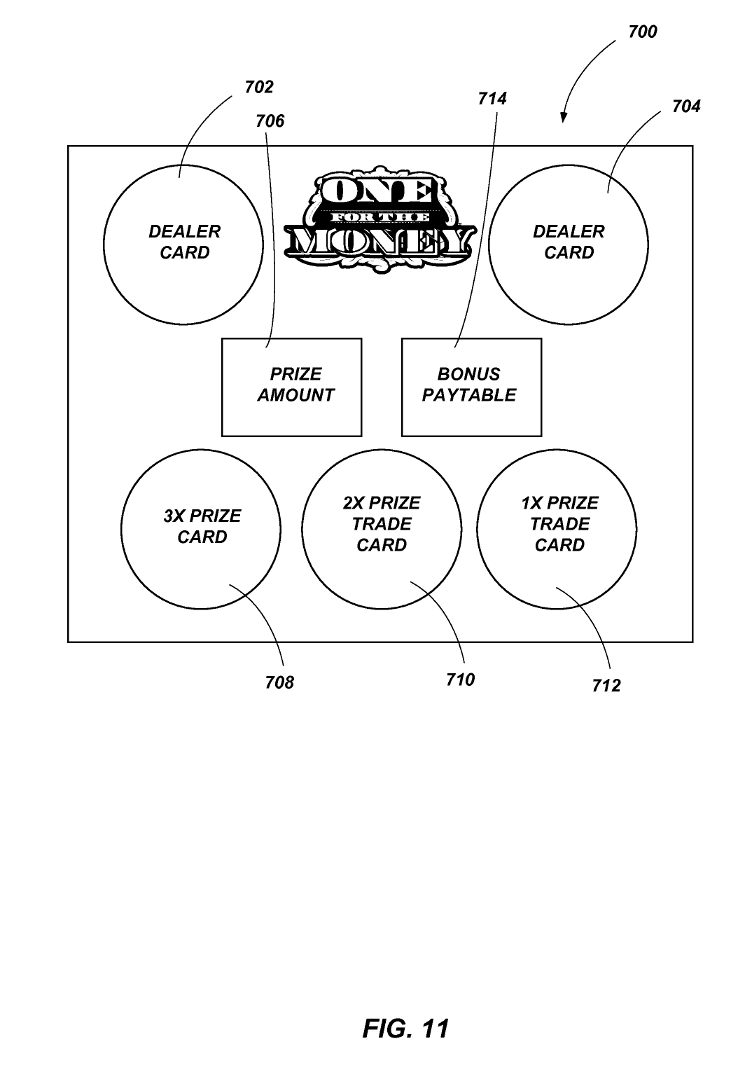

With reference to FIG. 11, a schematic of a wagering game implemented as a scratch card 700 is shown. An ante wager and bonus wager may be accepted from a player by accepting payment for the scratch card. Dealing the cards may include providing the player with the scratch card 700 having individual dealer cards (e.g., two cards 702, 704) and individual player cards (e.g., three cards 708, 710, 712) that are initially covered. Each of the player cards 708, 710, 712 may have a corresponding multiplier of a prize amount 706, which is initially covered. For example, if the first player card 708 has a greater rank than the highest ranking dealer card 702, 704, the payout may be 3× the prize amount 706, if the second player card 710 has a greater rank than the highest ranking dealer card 702, 704, the payout may be 2× the prize amount 706, and if the third player card 712 has a greater rank than the highest ranking dealer card 702, 704, the payout may be 1× the prize amount 706. In other embodiments, all wagers have a 1:1 payout. Both dealer cards 702, 704 and the prize amount 706 may be exposed (e.g., by removing the coverings) and, as above, the highest ranking dealer card is selected. The player cards 708, 710, 712 may be exposed and the player is enabled to “trade” cards by selecting the card having the highest rank and highest payout.

The ante wager may be resolved by visually comparing the player cards 708, 710, 712 to the dealer cards 702, 704 and determining whether any of the player cards 708, 710, 712 outrank the highest ranking dealer card 702, 704. The bonus wager may be resolved by visually determining whether the bonus wager (e.g., Card Bonus wager) may win if the best (e.g., five-card) poker hand formed from the combination of cards from the player hand and dealer hand at least matches a minimum bonus rank as shown in paytable 714, and otherwise loses.

While certain illustrative embodiments have been described in connection with the figures, those of ordinary skill in the art will recognize and appreciate that the scope of this disclosure is not limited to those embodiments explicitly shown and described herein. Rather, many additions, deletions, and modifications to the embodiments described herein may result in embodiments within the scope of this disclosure, such as those specifically claimed, including legal equivalents. In addition, features from one disclosed embodiment may be combined with features of another disclosed embodiment while still being within the scope of this disclosure, as contemplated by the inventors.

What is claimed is:

1. A method of administering a wagering game, comprising:
accepting from at least one player at a player position on a playing device layout an ante wager of at least one tangible gaming chip at an ante wager area on the playing device layout;
dealing at least one card from a randomized set of physical playing cards to the at least one player at the player position for a player hand;
dealing at least one card from the randomized set of physical playing cards for a dealer hand to a dealer position;
allowing the at least one player to view the player hand;
administering an opportunity for the at least one player to trade at least one card of the player hand;
exposing the dealer hand to the at least one player;
comparing a highest ranking card of the player hand to a highest ranking card of the dealer hand; and
resolving the ante wager comprising:
removing at least one tangible gaming chip from the playing device layout if the highest ranking card of the dealer hand outranks the highest ranking card of the player hand; and
paying at least one tangible gaming chip to the at least one player if the highest ranking card of the player hand outranks the highest ranking card of the dealer hand.

2. The method of claim 1, wherein resolving the ante wager further comprises returning at least one tangible gaming chip to the at least one player when the highest ranking card of the player hand is equal in rank to the highest ranking card of the dealer hand.

3. The method of claim 1, wherein administering an opportunity for the at least one player to trade at least one card of the player hand comprises accepting from the at least one player at the player position a trade wager of at least one tangible gaming chip at a trade wager area on the playing device layout.

4. The method of claim 3, wherein administering an opportunity for the at least one player to trade at least one card of the player hand further comprises:
receiving at least one card from the player hand; and
replacing the at least one card with a different card from the randomized set of physical playing cards.

5. The method of claim 3, further comprising selecting the trade wager to equal the ante wager.

6. The method of claim 3, further comprising, after allowing the at least one player to view the player hand, accepting a raise wager from the at least one player.

7. The method of claim 6, further comprising selecting the raise wager to equal the ante wager.

8. The method of claim 6, further comprising accepting only one of the raise wager from the at least one player and the trade wager from the at least one player.

9. The method of claim 6, further comprising accepting the raise wager from the at least one player after accepting the trade wager from the at least one player.

10. The method of claim 6, further comprising paying the ante wager, the raise wager, and the trade wager according to a single paytable.

11. The method of claim 1, further comprising:
selecting the player hand to comprise one card; and
selecting the dealer hand to comprise two cards.

12. The method of claim 1, further comprising accepting a bonus wager from the at least one player before exposing the dealer hand to the at least one player.

13. The method of claim 12, further comprising paying the bonus wager when a combination of one card of the player hand and two cards of the dealer hand form a three-card poker hand having a predetermined minimum bonus rank.

14. A method of administering a wagering game, comprising:
providing a playing device layout comprising at least one player position and a dealer area, the at least one player position of the playing device layout bearing at least three distinct wager areas comprising an ante wager area, a raise wager area, and a trade wager area, and a player card receiving area, the ante wager area, the raise wager area, and the trade wager area, each defined by separate insignia displayed on the playing device layout, the dealer area bearing a dealer card receiving area defined by insignia displayed on the playing device layout;
accepting from at least one player at the at least one player position an ante wager of at least one tangible gaming chip at the ante wager area;
dealing one card from a randomized set of physical playing cards to the at least one player for a player hand to the player card receiving area;
dealing two cards from the randomized set of physical playing cards for a dealer hand to the dealer card receiving area;
allowing the at least one player to view the player hand;
administering an opportunity for the at least one player to trade at least one card of the player hand, comprising at least one of:
receiving an indication of standing from the at least one player;
accepting from the at least one player at the at least one player position a trade wager of at least one tangible gaming chip at the trade wager area on the playing device layout; and
accepting from the at least one player at the at least one player position a raise wager of at least one tangible gaming chip at the raise wager area on the playing device layout;
exposing the dealer hand to the at least one player at the dealer card receiving area;
comparing the player hand to the dealer hand; and
resolving at least one of the ante wager, the trade wager, and the raise wager comprising at least one of:
removing at least one tangible gaming chip from the playing device layout when at least one card of the two cards of the dealer hand outranks the one card of the player hand;
paying at least one tangible gaming chip to the at least one player when the one card of the player hand outranks at least one card of the two cards of the dealer hand; and
returning at least one tangible gaming chip to the at least one player when the one card of the player hand is equal in rank to at least one card of the two cards of the dealer hand.

15. The method of claim 14, further comprising selecting the trade wager and the raise wager to equal the ante wager.

16. The method of claim 14, further comprising paying the ante wager, the raise wager, the trade wager according to a paytable comprising:

| Player Card | Odds |
|---|---|
| 6 or higher | 1 to 1 |
| 5 | 2 to 1 |
| 4 | 5 to 1 |
| 3 | 10 to 1 |

17. The method of claim 14, further comprising, after receiving the trade wager from the at least one player:
receiving the one card from the player hand; and
replacing the one card with a different card from the randomized set of physical playing cards.

18. The method of claim 14, further comprising, after receiving the trade wager from the at least one player, receiving one of the raise wager and an indication of standing from the at least one player.

19. The method of claim 14, further comprising selecting a highest ranking card of the two cards of the dealer hand to be compared to the one card of the player hand.

20. The method of claim 14, further comprising:
accepting a bonus wager from the at least one player before exposing the dealer hand to the at least one player at the dealer card receiving area; and
paying the bonus wager when a combination of the one card of the player hand and the two cards of the dealer hand form a three-card poker hand having a predetermined minimum bonus rank.

21. A method of administering a wagering game over a network utilizing a processor, comprising:
receiving, at a processor, an indication that an ante wager to participate in the wagering game is accepted from a player;
determining, utilizing the processor, a player hand associated with the player, the player hand including at least one randomized playing card from a set of playing cards;
determining, utilizing the processor, a dealer hand, the dealer hand including at least one randomized playing card from the set of playing cards;
providing, from the processor, the player hand to a user device associated with the player for displaying the player hand on the associated user device;
receiving, at the processor, an election from the at least one player to trade at least one card of the player hand;
providing, from the processor, the dealer hand to the user device associated with the player for displaying the dealer hand on the associated user device; and
resolving the ante wager by comparing a highest ranking card of the dealer hand to a highest ranking card of the player hand.
